(19) United States
(12) Patent Application Publication
(10) Pub. No.: US 2016/0363550 A1
(43) Pub. Date: Dec. 15, 2016

(54) MOBILE SAMPLE ANALYSIS SYSTEM, MOBILE MEASUREMENT DEVICE, AND METHOD FOR PROVIDING ANALYSIS RESULTS

(71) Applicant: Maxim Integrated Products, Inc., San Jose, CA (US)

(72) Inventors: Ronald B. Koo, Los Altos, CA (US); Henry Grage, Johns Creek, GA (US)

(21) Appl. No.: 15/244,600

(22) Filed: Aug. 23, 2016

Related U.S. Application Data
(63) Continuation-in-part of application No. 15/147,103, filed on May 5, 2016.
Application No. 15/147,103 is a continuation-in-part of application No. 14/859,943, filed on Sep. 21, 2015.
Application No. 14/859,943 is a continuation-in-part of application No. 14/972,857, filed on Dec. 17, 2015.
(60) Provisional application No. 62/156,954, filed on May 5, 2015.
(60) Provisional application No. 62/203,637, filed on Aug. 11, 2015.
(60) Provisional application No. 62/211,959, filed on Aug. 31, 2015.
(60) Provisional application No. 62/213,743, filed on Sep. 3, 2015.
(60) Provisional application No. 62/238,837, filed on Oct. 8, 2015.

(51) Int. Cl. G01N 27/02; H04L 29/08; G06F 19/00; H04W 4/00

(52) U.S. Cl. CPC G01N 27/02; H04W 4/008; H04L 67/10; G06F 19/322

(57) ABSTRACT

A system is described that obtains a sample (e.g., a biological fluid sample, a gas sample) and provides data to the person by way of a mobile electronic device. The system can include a mobile detection or measurement device having a sensor configured to receive at least a portion of a fluid sample and a wireless transmitter or transceiver configured to transmit information associated with electrical signals received from the sensor, where the electrical signals are at least partially attributable to one or more analytes in the fluid sample. The system can further include a mobile electronic device in communication with the mobile detection or measurement device. The mobile electronic device may include a short-range wireless transceiver configured to receive the information from the mobile detection or measurement device.

### CROSS-REFERENCE TO RELATED APPLICATIONS

The present application is a continuation-in-part of U.S. Non-Provisional patent application Ser. No. 15/147,103, filed May 5, 2016, and titled “ELECTRIC-FIELD IMAGER FOR ASSAYS,” which is a continuation-in-part of U.S. Non-Provisional patent application Ser. No. 14/859,943, filed Sep. 21, 2015, and titled “ELECTRIC-FIELD IMAGER FOR ASSAYS,” which claims the benefit under 35 U.S.C. §119(e) of U.S. Provisional Patent Application No. 62/156,954, filed May 5, 2015, and titled “ELECTRIC-FIELD IMAGER FOR VISUALIZING CELLS.” The present application is also a continuation-in-part of U.S. Non-Provisional patent application Ser. No. 14/972,857, filed Dec. 17, 2015, and titled “H-FIELD IMAGER FOR ASSAYS,” which claims the benefit under 35 U.S.C. §119(e) of U.S. Provisional Patent Application No. 62/203,637, filed Aug. 11, 2015, and titled “H-FIELD IMAGER FOR ASSAYS.” The present application also claims the benefit under 35 U.S.C. §119(e) of U.S. Provisional Patent Application No. 62/211,959, filed Aug. 31, 2015, and titled “MULTI-MODAL IMAGER FOR ASSAYS.” The present application also claims the benefit under 35 U.S.C. §119(e) of U.S. Provisional Patent Application No. 62/213,743, filed Sep. 3, 2015, and titled “MOBILE SAMPLE ANALYSIS SYSTEM AND METHOD FOR PROVIDING ANALYSIS RESULTS.” The present application also claims the benefit under 35 U.S.C. §119(e) of U.S. Provisional Patent Application No. 62/238,837, filed Oct. 8, 2015, and titled “MOBILE MEASUREMENT DEVICE.”

The non-provisional and provisional patent applications cross-referenced above are all incorporated herein by reference in their entireties.

### BACKGROUND

The determination of components in biological fluids (e.g., blood, urine, etc.) and other materials (e.g., gas samples, etc.) is continuing to increase in importance. Biological fluid tests can be used in a health care environment to determine physiological and/or biochemical states, such as disease, mineral content, pharmaceutical drug effectiveness, and/or organ function. For example, an individual may wish to determine an analyte concentration within that individual's blood to manage a health condition, such as diabetes. Often, the individual must go to a diagnostic laboratory or medical facility to have blood drawn and then wait (often for days) for analysis results, which can be inconvenient. Sometimes, the individual must schedule a follow-up visit with a healthcare provider to review the analysis results, which can also add costs. Further, employers may lose productivity from their employees when the employees have to wait for blood tests, results, and follow-up medical visits during regular work time. In addition, health care organizations are under constant pressure to improve their operating efficiency. When health care professionals have to wait for test results, they spend extra effort re-familiarizing themselves with the particulars of the patients' conditions and then contacting the patients with the test results and what, if any, actions to take.

### SUMMARY

A system is described that obtains a sample (e.g., a biological fluid sample, a gas sample) and provides data to the person by way of a mobile electronic device. The system can include a mobile detection or measurement device having a sensor configured to receive at least a portion of a fluid sample and a wireless transmitter or transceiver configured to transmit information associated with electrical signals received from the sensor, where the electrical signals are at least partially attributable to one or more analytes in the fluid sample. The system can further include a mobile electronic device in communication with the mobile detection or measurement device. The mobile electronic device may include a short-range wireless transceiver configured to receive the information from the mobile detection or measurement device.

This Summary is provided solely to introduce user matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. The use of the same reference numbers in different instances in the description and the figures may indicate similar or identical items.

FIG. 1 is a top elevation view illustrating a mobile detection or measurement device for collecting a sample in accordance with an example implementation of the present disclosure.

FIG. 2 is a side elevation view illustrating a lancet in accordance with an example implementation of the present disclosure.

FIG. 3A is an environmental view illustrating a lancet for pricking a finger to obtain a drop of blood in accordance with an example implementation of the present disclosure.

FIG. 3B is an environmental view illustrating the mobile detection or measurement device collecting a drop of blood from a finger that has been pricked by a lancet in accordance with an example implementation of the present disclosure.

FIG. 4 is a side elevation view illustrating the mobile detection or measurement device containing a sample proximate to a mobile electronic device in accordance with an example implementation of the present disclosure.

FIG. 5 is a top view illustrating a near field communication-enabled mobile device where a user interface is displaying biological fluid analysis results, in accordance with an example implementation of the present disclosure.

FIG. 6 is an environmental view illustrating a mobile device including a controller that can communicate with a mobile detection or measurement device and a network, in accordance with an example implementation of the present disclosure.

FIG. 7A is an environmental view illustrating a collaborative cloud computing network accessible by various medical service provider entities and patients, in accordance with an example implementation of the present disclosure.

FIG. 7B is an environmental view illustrating a network of devices that can be connected to one another by a collaborative cloud computing network, in accordance with an example implementation of the present disclosure, wherein a patient performs a blood test on herself.

FIG. 7C is an environmental view illustrating a network of devices that can be connected to one another by a collaborative cloud computing network, in accordance with an example implementation of the present disclosure, wherein a nurse performs a blood test on a patient and results are displayed and/or stored at various network locations.

FIG. 8 is a flow diagram illustrating a method for sample analysis using a mobile detection or measurement device and a mobile electronic device, such as the devices shown in FIGS. 1 through 7C, in accordance with an example implementation of the present disclosure.

FIG. 9 is a block diagram illustrating various components of a measurement device, in accordance with an example implementation of the present disclosure.

FIG. 10 is a block diagram illustrating various components of a measurement device, in accordance with an example implementation of the present disclosure.

FIG. 11 is a block diagram illustrating various components of a measurement device, in accordance with an example implementation of the present disclosure.

FIG. 12 is a schematic showing a single-substrate integrated laboratory implementing a measurement device, such as the measurement device shown in any of FIGS. 9 through 11, in accordance with an example implementation of the present disclosure.

FIG. 13 is a schematic showing an example sensor architecture of a measurement device, such as the measurement device shown in any of FIGS. 9 through 11, in accordance with an example implementation of the present disclosure.

FIG. 14 is a schematic showing an internal portion of the example sensor architecture illustrated in FIG. 13, in accordance with an example implementation of the present disclosure.

FIG. 15 is a schematic view of an electric-field imager, in accordance with an example implementation of the present disclosure.

FIG. 16A illustrates an example of agglutination assaying with an electric-field imager, such as the electric-field imager shown in FIG. 15, wherein beads covered by antibodies are dispersed.

FIG. 16B illustrates an example of agglutination assaying with an electric-field imager, such as the electric-field imager shown in FIG. 15, wherein beads covered by antibodies are agglutinated.

FIG. 17 is a schematic side view of an electric-field imager, such as the electric-field imager shown in FIG. 15, wherein the electric-field imager is configured to detect disturbances in a vertical electric field, in accordance with an example implementation of the present disclosure.

FIG. 18 is a schematic side view of an electric-field imager, such as the electric-field imager shown in FIG. 15, wherein the electric-field imager is configured to detect disturbances in a horizontal electric field, in accordance with an example implementation of the present disclosure.

FIG. 19 is a schematic view of a magnetic-field imager, in accordance with an example implementation of the present disclosure.

FIG. 20 is a schematic view of a magnetic-field imager, such as the magnetic-field imager shown in FIG. 19, wherein the magnetic-field imager is configured to detect antibodies tagged with superparamagnetic nanoparticles, in accordance with an example implementation of the present disclosure.

FIG. 21A illustrates an example of agglutination assaying with a magnetic-field imager, such as the magnetic-field imager shown in FIG. 19, wherein functionalized magnetic beads are dispersed.

FIG. 21B illustrates an example of agglutination assaying with a magnetic-field imager, such as the magnetic-field imager shown in FIG. 19, wherein functionalized magnetic beads are agglutinated.

FIG. 22A illustrates an example of coagulation assaying with a magnetic-field imager, such as the magnetic-field imager shown in FIG. 19, wherein magnetic cylinders are in a first orientation due to presence or absence of a magnetic field.

FIG. 22B illustrates an example of coagulation assaying with a magnetic-field imager, such as the magnetic-field imager shown in FIG. 19, wherein magnetic cylinders are in a second orientation due to presence or absence of a magnetic field.

FIG. 23A is a schematic view of a multi-modal imaging system, in accordance with an example implementation of the present disclosure, wherein functionalized magnetic beads are dispersed over an active sensor area defined by two or more sensor types.

FIG. 23B is a schematic view of the multi-modal imaging system, in accordance with an example implementation of the present disclosure, wherein functionalized magnetic beads are agglutinated over portions of an active sensor area defined by two or more sensor types.

FIG. 24 is a schematic view of a multi-modal imaging system, in accordance with an example implementation of the present disclosure, wherein at least one cell and one or more antibodies tagged with superparamagnetic nanoparticles are detectable in an active sensor area defined by two or more sensor types.

### DETAILED DESCRIPTION

Overview

Some types of point-of-care tests exist, but can still be inconvenient. A point-of-care test may require a benchtop instrument, which takes up space and can be expensive, and costly cassettes used in many of point-of-care benchtop instruments have to be filled with a needle. While glucose strips and their small handheld meters may be somewhat mobile, patients desire smaller and faster devices.

Accordingly, techniques are described that may be implemented with a system that obtains a sample (e.g., a biological fluid sample, a gas sample) and provides data to the person by way of a mobile electronic device. The system can include a mobile detection or measurement device having a sensor configured to receive at least a portion of a fluid sample and a wireless transmitter or transceiver configured to transmit information associated with electrical signals received from the sensor, where the electrical signals are at least partially attributable to one or more analytes in the fluid sample. The system can further include a mobile electronic device in communication with the mobile detection or measurement device. The mobile electronic device may include a short-range wireless transceiver configured to receive the information from the mobile detection or measurement device.

A fully integrated mobile detection or measurement device is also described herein. In embodiments, the mobile detection or measurement device comprises a single-substrate integrated laboratory with at least one sensor configured to receive at least a portion of a fluid sample (e.g., liquid or gas of interest), the sensor being mounted on or within the single-substrate integrated laboratory. Examples of fluid samples that can be tested with the mobile detection or measurement device include, but are not limited to, biological fluid samples (e.g., blood, sweat, saliva, etc.), air samples, water samples, chemical mixtures/solutions, and so forth. A controller and a wireless transmitter may also be mounted on or within the single-substrate integrated laboratory. The controller is coupled to the sensor and configured to receive electrical signals from the sensor in connection with one or more analytes detected in the fluid sample. The controller can cause the wireless transmitter to transmit the electrical signals or data associated with the electrical signals to a computing device. For example, the mobile detection or measurement device may exchange data with (and in some embodiments, receive power from) a mobile device (e.g., smartphone, tablet, notebook, media player, etc.), a desktop computer, or the like. For example, the mobile detection or measurement device can wirelessly transmit data associated with the electrical signals generated by the sensor to a mobile device, and in some embodiments, the mobile detection or measurement device can also be wirelessly powered (e.g., via near-field communication (NFC) or other inductive coupling) by the mobile device.

Various sensor implementations are also described herein. For example, chemistry-based sensors, electric-field sensors, magnetic-field sensors, optical sensors, and multi-modal sensors are described herein. It should be understood that any of the sensors described herein can operate as standalone devices and can also be implemented in an embodiment of the mobile detection or measurement device. In some embodiments, two or more of the sensor implementations can be combined into the mobile detection or measurement device. In some embodiments, for example, the mobile detection or measurement device can include two or more of: a chemistry-based sensor, an electric-field sensor, a magnetic-field sensor, an optical sensor, or the like.

Example Implementations of a Mobile Analysis System

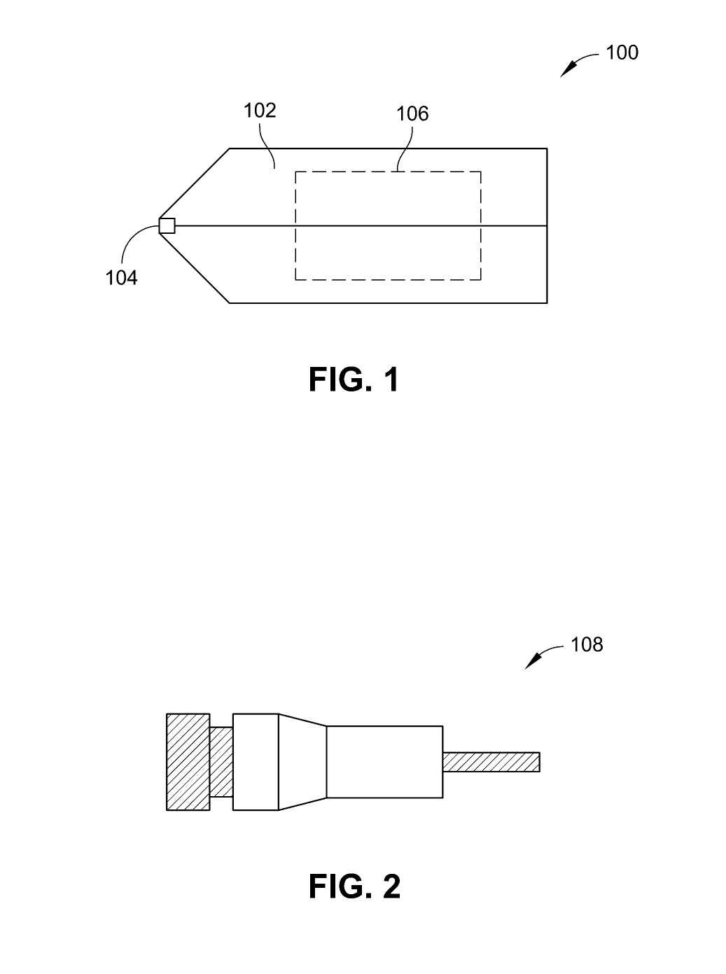

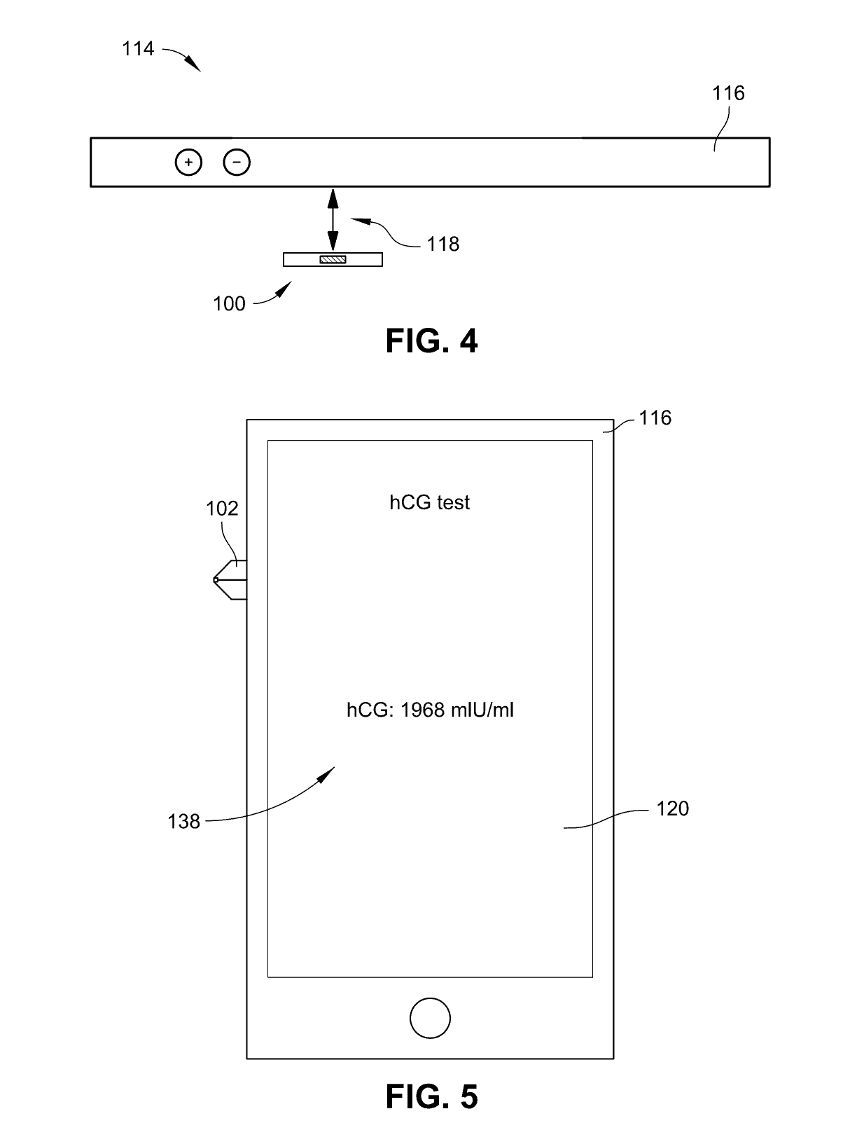

FIGS. 1 through 7C illustrate a mobile analysis system 114 in accordance with various embodiments of the present disclosure. As shown in FIG. 4, the mobile sample analysis system 114 can include a mobile detection or measurement device 100 and a mobile electronic device 116. Some examples of samples 112 that can be sampled and/or analyzed using the technology herein may include solid biological samples (e.g., animal tissue, plants, etc.), gas samples (e.g., carbon dioxide, oxygen, etc.), and/or biological fluids (e.g., blood, sweat, urine, etc.).

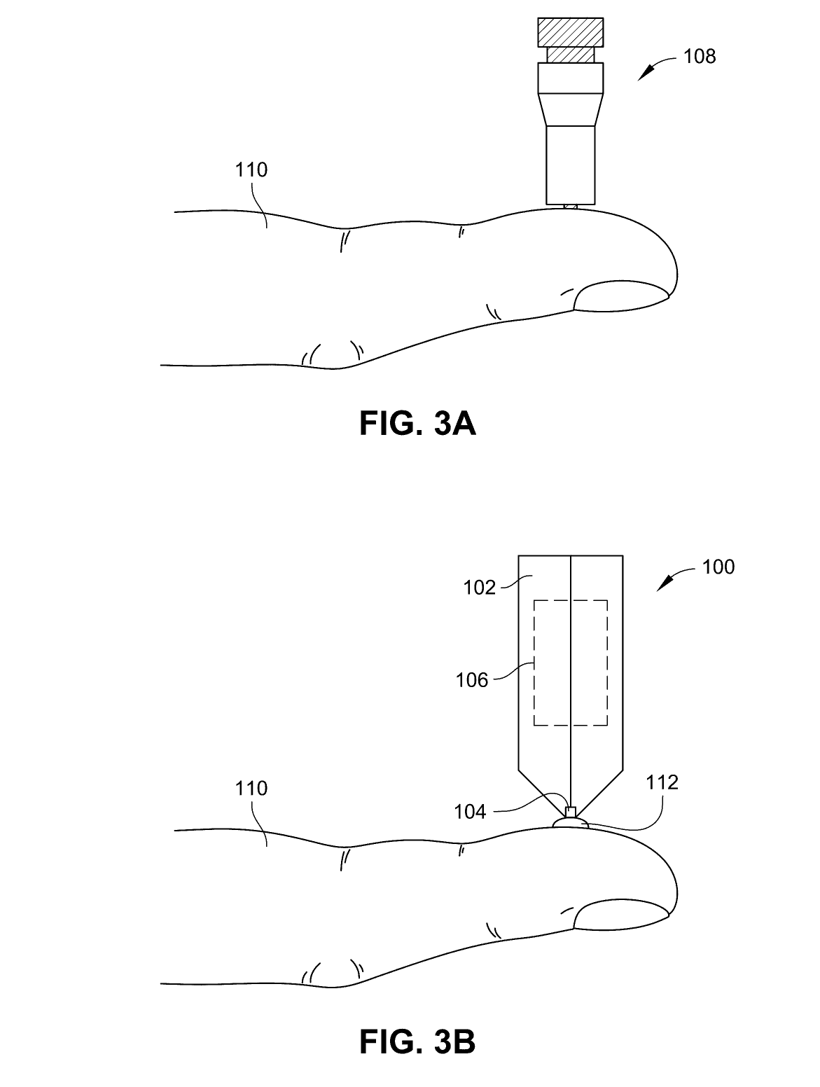

FIGS. 1 and 3B illustrate an embodiment of a mobile detection or measurement device 100 configured to collect a sample 112 and provide sample information to a mobile electronic device 116. As described herein, the mobile detection or measurement device 100 is configured to collect, measure, and/or detect information relating to the sample 112. In some embodiments, the mobile detection or measurement device 100 comprises dimensions smaller than fourteen centimeters by four centimeters by one centimeter (14 cm×4 cm×1 cm).

The mobile detection or measurement device 100 can include a sampling tip 102 for collecting a sample 112 (e.g., a biological fluid sample). In some embodiments, the sampling tip 102 can include a needle and/or a tube that can collect and/or contain a sample 112. In some embodiments, the sampling tip 102 can collect a biological fluid sample using capillary action and/or other pumping means (e.g., a MEMS micro-pump). In some embodiments, the sampling tip 102 can include a blood sampling needle configured to collect a biological fluid sample including blood. In some embodiments, the mobile detection or measurement device 100 can include a microfluidic cassette. In some embodiments, the mobile detection or measurement device 100 can include a gas sampling device configured to collect and/or receive a sample of gas. For example, the gas sampling device can include a micro-machined and/or 3D printed gas sampling device. The mobile detection or measurement device 100 can also include other types of sensors and/or sampling devices.

In embodiments, the mobile detection or measurement device 100 includes a sensor module 104 configured to integrate one or more laboratory functions (e.g., chemical analysis, electrochemical detection, capacitively coupled contactless conductivity detection, etc.) on a single substrate (e.g., a signal processing integrated chip, microfluidic paper-based analytical devices (μPADs)). For example, the sensor module 104 can perform a chemical analysis (e.g., measurement) of a sample 112, such as a biological fluid sample (e.g., determination of components of a blood or urine sample, such as an analyte, glucose, protein, bilirubin, urobilinogen, ketones, nitrite, pH, specific gravity, erythrocytes, leukocytes, antibodies, cholesterol, insulin, etc.), perform a chemical analysis of a gas sample (e.g., carbon dioxide, air, etc.), perform a chemical analysis of a solid material sample (e.g., skin tissue, plant matter, etc.), store sample information (e.g., raw information regarding the biological fluid sample components), and/or provide the sample information to another device (e.g., a short-range wireless communication transceiver 106, a mobile electronic device 116, etc.).

In some embodiments, the sensor module 104 can include a lab-on-a-chip device (e.g., a microfluidic lab-on-a-chip), a micro total analysis system (μTAS), and/or other microelectromechanical (MEMS) devices. For example, the sensor module 104 can include a lab-on-a-chip device configured to contact a sample 112 including a patient's blood, detect an amount of glucose in the patient's blood, and store information regarding the amount of glucose. Additionally, the lab-on-a-chip device can be configured to provide the information regarding the amount of glucose to another device, such as a mobile electronic device 116. Other types of biological fluids may also be used in collecting a biological fluid sample 112, such as urine, semen, saliva, mucus, tissue fluids, and/or sweat. In some embodiments, the sensor module 104 includes a lab-on-a-chip device configured to contact a sample 112 including a patient's blood, measure an analyte level within the patient's blood, and store information regarding the analyte level. Utilizing the mobile electronic device 116, the user may be able to access the user's analyte level to determine whether the user is meeting goals based upon the user's analyte level.

Additionally, the sensor module 104 may be configured to obtain a variety of information pertaining to other types of sample(s) 112 and/or other types of chemical analyses (e.g., protein testing of saliva, urinalysis, sweat chloride testing, detection of illegal drugs in blood, etc.). In some embodiments, the sensor module 104 may utilize electrochemical impedance spectroscopy (EIS) analysis and/or cyclic voltammetry (CV).

As shown in FIGS. 3A and 3B, a patient's finger can be pricked using a lancet 108 (e.g., as shown in FIG. 2) or other device to provide a biological fluid sample (e.g., sample 112) that includes blood. In some embodiments, the lancet 108 may be separate from the mobile detection or measurement device 100. In other embodiments, the lancet 108 may be coupled to and/or integral with the mobile detection or measurement device 100. Subsequent to using a lancet 108 on a patient's finger 110 for providing a blood sample, a mobile detection or measurement device 100 and microfluidic sampling tip 102 can be used to collect (e.g., using capillary action) at least a portion of the sample 112, and the sensor module 104 can analyze the sample 112 for a specific component and/or property, such as a biomarker that indicates a specific disease.

As shown in FIG. 1, the mobile detection or measurement device 100 can also include a short-range wireless communication transceiver 106. In embodiments, the short-range wireless communication transmitter or transceiver 106 can be mechanically and/or electrically coupled to the microfluidic sampling tip 102 and/or the sensor module 104 and integral with the mobile detection or measurement device 100. The short-range wireless communication transmitter or transceiver 106 can be configured to provide, present, and/or transmit biological fluid sample information using a near field communication protocol. A near field communication (NFC) protocol enables smartphones (e.g., mobile electronic device 116) and/or other devices (e.g., mobile detection or measurement device 100) to establish communication with each other by touching each device together and/or by bringing them into proximity (e.g., a distance of 10 cm or less). In some embodiments, the short-range wireless communication transceiver 106 may comprise a field communication antenna or a loop antenna (e.g., a transmitter coil, a receiver coil) configured to operate in the radio frequency ISM band of 13.56 MHz on ISO/IEC 18000-3 air interface and at rates ranging from 106 kbit/s to 424 kbit/s (near field communications frequencies). In some embodiments, the mobile detection or measurement device 100 may include other antenna types and/or other communication capabilities (e.g., WiFi, electromagnetic induction, Bluetooth, 24 GHz/60 GHz passive radio, etc.).

In some embodiments, the mobile detection or measurement device 100 and/or the short-range wireless communication transceiver 106 can be configured to utilize wireless energy transmission for powering the mobile detection or measurement device 100. For example, the short-range wireless communication transceiver 106 can include a near field communication antenna that is configured to receive power transferred over a distance using a magnetic field and inductive coupling between the short-range wireless communication transceiver 106 and a corresponding antenna coupled to a power source in another device (e.g., a mobile electronic device 116). The mobile detection or measurement device 100 and/or the short-range wireless communication transceiver 106 may also utilize other types of wireless energy transmission or power storage technology.

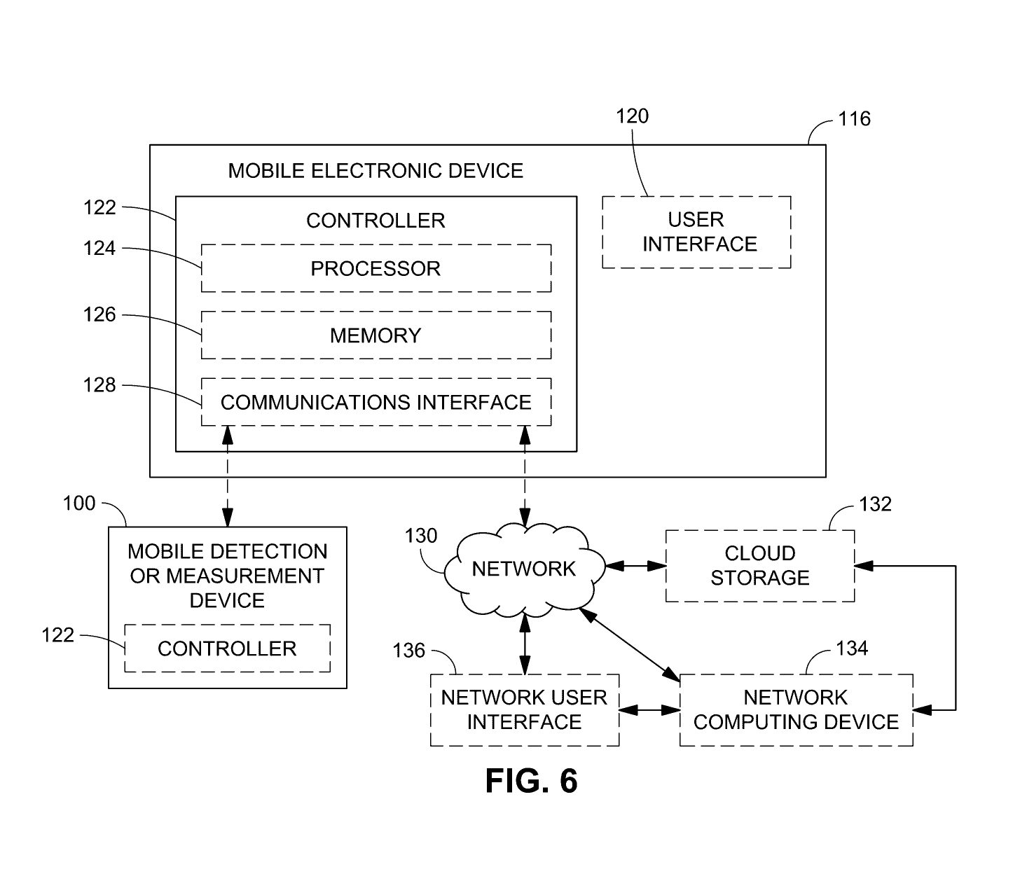

As illustrated in FIGS. 4 through 6, an embodiment of the mobile sample analysis system 114 includes a mobile detection or measurement device 100 and a mobile electronic device 116. Such mobile sample analysis systems 114 can be utilized to provide a sample 112 analysis. As shown in FIG. 6, the mobile electronic device 116 can be configured to communicate with a mobile detection or measurement device 100 and/or a network 130 (e.g., a cloud computing network, which may be coupled to a cloud storage 132, which can further include a memory located in the cloud). For example, the network 130 and/or the cloud storage 132 may comprise software and/or software services that are executed (e.g., run) via the Internet (e.g., Software-as-a-Service functionality). In some embodiments, the network 130 implements a cloud computing network with shared storage and/or processing resources for providing services or features offered by the mobile sample analysis system 114. For example, the network 130 can comprise a cloud computing network that includes one or more processors configured to determine one or more detection or measurement results based upon the information from the mobile detection or measurement device 100, where the detection or measurement results may be transmitted to the cloud computing network from the mobile electronic device 116 or another computing device capable of interfacing with the mobile detection or measurement device 100 (e.g., a computer having an NFC reader or the like). In some embodiments, the cloud computing network may be configured to supply one or more software modules executable by the mobile electronic device 116 to determine one or more detection or measurement results based upon the information from the mobile detection or measurement device 100.

In some embodiments, the mobile electronic device 116 can include a near field antenna, such as a loop antenna (e.g., a transmitter coil, a receiver coil) configured to operate in the radio frequency ISM band of 13.56 MHz on ISO/IEC 18000-3 air interface and at rates ranging from 106 kbit/s to 424 kbit/s (near field communications frequencies). The mobile detection or measurement device 100 can alternatively or additionally include other antenna types and/or other communication systems (e.g., WiFi, Bluetooth, electromagnetic induction, etc.). Some examples of a mobile electronic device 116 can include a smartphone, a tablet computer, or the like. As shown in FIGS. 4 and 5, when the mobile detection or measurement device 100 is disposed proximate to the mobile electronic device 116, short-range wireless communication 118 can be initiated (e.g., by controller 122) for facilitating transfer and/or transmission of sample information and/or power between the mobile electronic device 116 and the mobile detection or measurement device 100.

Referring to FIG. 6, the mobile electronic device 116 includes components that can operate under computer control. For example, a processor 124 can be included with or in the mobile electronic device 116 and/or controller 122 to control the components and functions of the mobile electronic device 116 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the mobile electronic device 116. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

As shown in FIG. 6, the mobile electronic device 116 can be communicatively coupled with the controller 122 for controlling the mobile detection or measurement device 100. In some embodiments, the controller 122 may include a processor 124, a memory 126, and/or a communications interface 128. In some embodiments, the controller 122 may be integrated into an integrated circuit (IC) with a user interface 120 (e.g., a screen, controls, a readout, etc.). In other embodiments, the controller 122, processor 124, memory 126, communications interface 128, and/or user interface 120 may be integrated into one system-in-package/module and/or one or more could be separate discrete components in an end system (e.g., mobile electronic device 116).

The processor 124 provides processing functionality for the controller 122 and may include any number of processors, micro-controllers, or other processing systems and resident or external memory for storing data and other information accessed or generated by the controller 122. The processor 124 may execute one or more software programs which implement the techniques and modules described herein. The processor 124 is not limited by the materials from which it is formed or the processing mechanisms employed therein and, as such, can be implemented via semiconductor(s) and/or transistors (e.g., electronic Integrated Circuits (ICs)), and so forth.

The controller 122 may include a memory 126. The memory 126 can be an example of tangible, computer-readable storage medium that provides storage functionality to store various data associated with operation of the mobile electronic device 116, such as software programs and/or code segments, or other data to instruct the processor 124, and possibly other components of the mobile electronic device 116, to perform the functionality described herein. Thus, the memory 126 can store data, such as a program of instructions for operating the mobile electronic device 116 (including its components), and so forth. It should be noted that while a single memory 126 is described, a wide variety of types and combinations of memory (e.g., tangible, non-transitory memory) can be employed. The memory 126 can be integral with the processor 124, can comprise stand-alone memory, or can be a combination of both.

The memory 126 may include, for example, removable and non-removable memory elements such as Random Access Memory (RAM), Read Only Memory (ROM), flash memory (e.g., a Secure Digital (SD) card, a mini-SD card, a micro-SD card), magnetic memory, optical memory, Universal Serial Bus (USB) memory devices, cloud storage 132, and so forth. In embodiments of the controller 122, the memory 126 may include removable Integrated Circuit Card (ICC) memory, such as memory provided by Subscriber Identity Module (SIM) cards, Universal Subscriber Identity Module (USIM) cards, Universal Integrated Circuit Cards (UICC), and so on.

The controller 122 may include a communications interface 128. The communications interface 128 can be operatively configured to communicate with components of the mobile electronic device 116, the mobile detection or measurement device 100, and/or a network 130. For example, the communications interface 128 can be configured to transmit data for storage in the mobile electronic device 116, retrieve data from storage in the mobile electronic device 116, and so forth. The communications interface 128 can also be communicatively coupled with the processor 124 to facilitate data transfer between components of the mobile electronic device 116, the mobile detection or measurement device 100, and the processor 124 (e.g., for communicating inputs to the processor 124 received from a device communicatively coupled with the mobile electronic device 116). It should be noted that while the communications interface 128 is described as a component of a mobile electronic device 116, one or more components of the communications interface 128 can be implemented as external components communicatively coupled to the mobile electronic device 116 via a wired and/or a wireless connection. The mobile electronic device 116 can also include and/or connect to one or more input/output (I/O) devices and/or a user interface 120 (e.g., via the communications interface 128), including, but not necessarily limited to a display, a screen, a mouse, a touchpad, a keyboard, and so on.

The communications interface 128 and/or the processor 124 can be configured to communicate with a variety of different networks, including, but not necessarily limited to a wide-area cellular telephone network, such as a 3G cellular network, a 4G cellular network, a near-field communication network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; a network computing device 134, a network user interface 136, and so on. Wired communications are also contemplated such as through USB, Ethernet, serial connections, and so forth. However, this list is provided by way of example only and is not meant to limit the present disclosure. Further, the communications interface 128 can be configured to communicate with a single network or multiple networks across different access points.

In some embodiments, a client device (e.g., a network computing device 134) associated with medical personnel can be utilized to retrieve detection and/or measurement results from the network 130 (e.g., cloud storage 132). For example, a patient or doctor (or other healthcare provider) may access the patient's detection and/or measurement results utilizing a client device. In other embodiments, a patient medical record service can retrieve detection and/or measurement results from the network 130 (e.g., cloud storage 132). For example, the patient medical record service may comprise a server, such as a network computing device 134, communicatively coupled with the cloud storage 132.

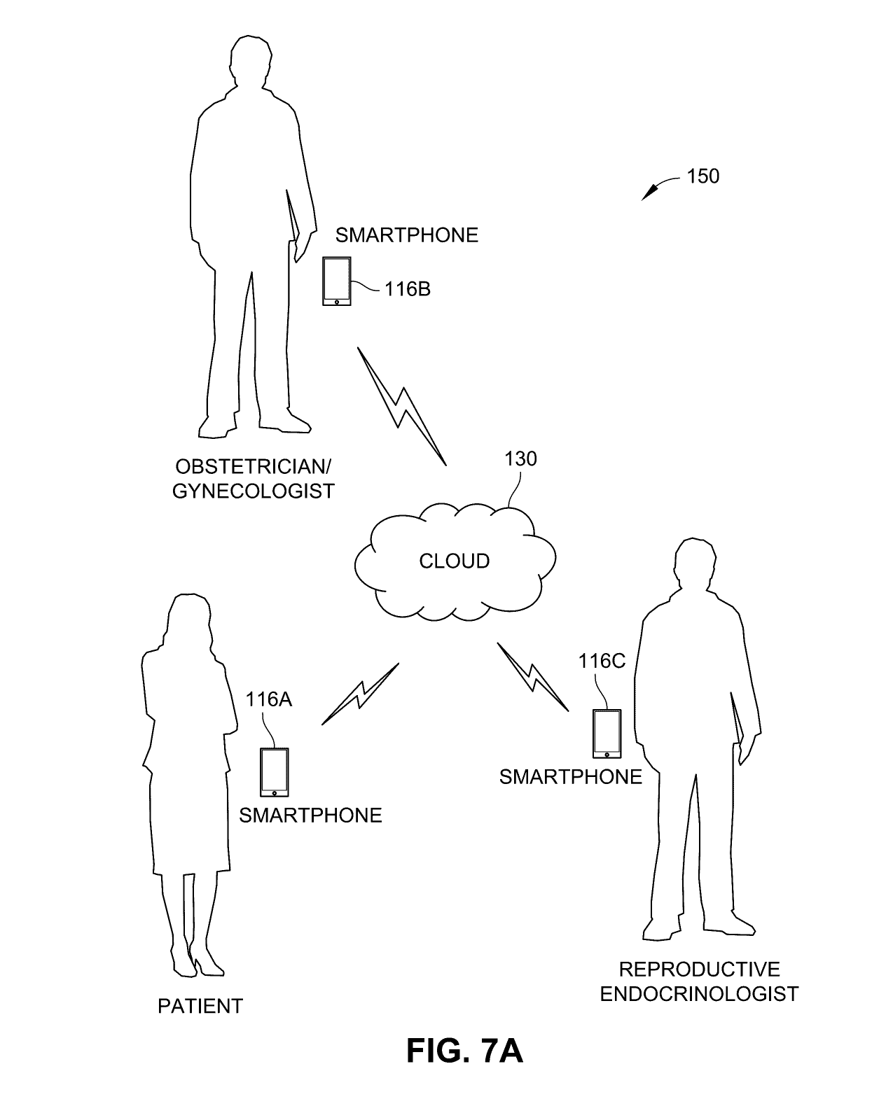

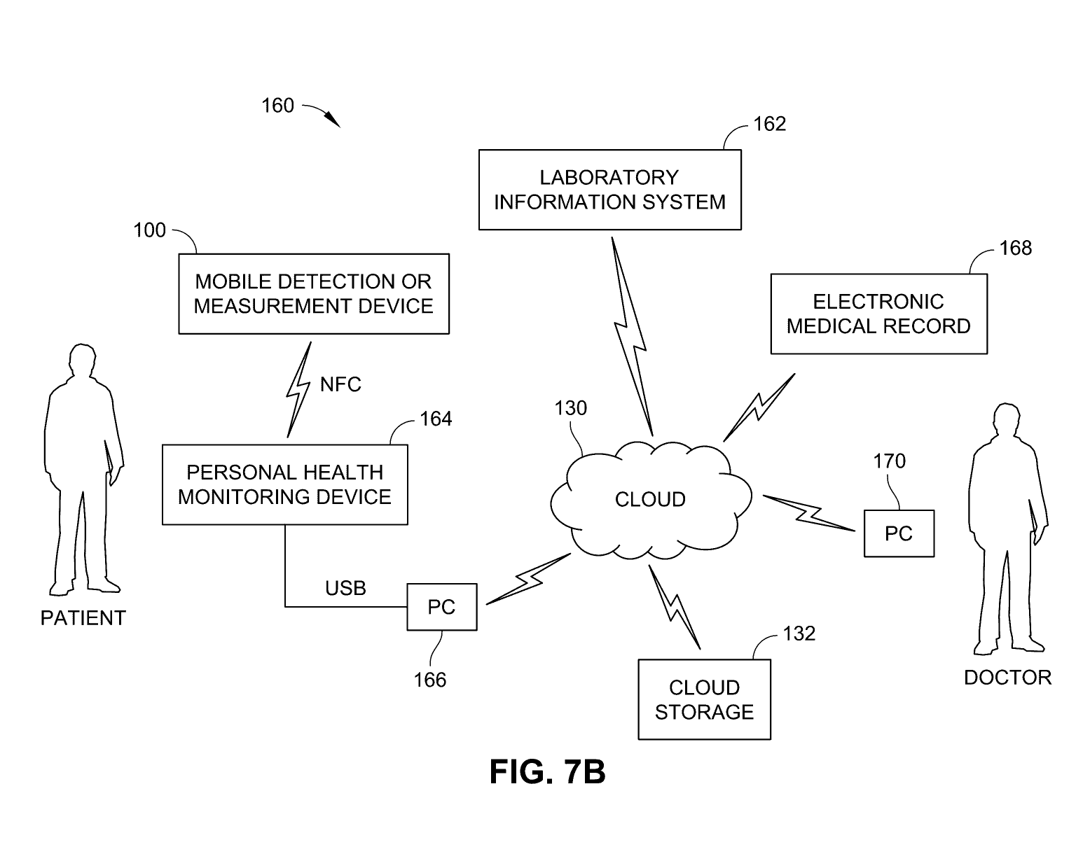

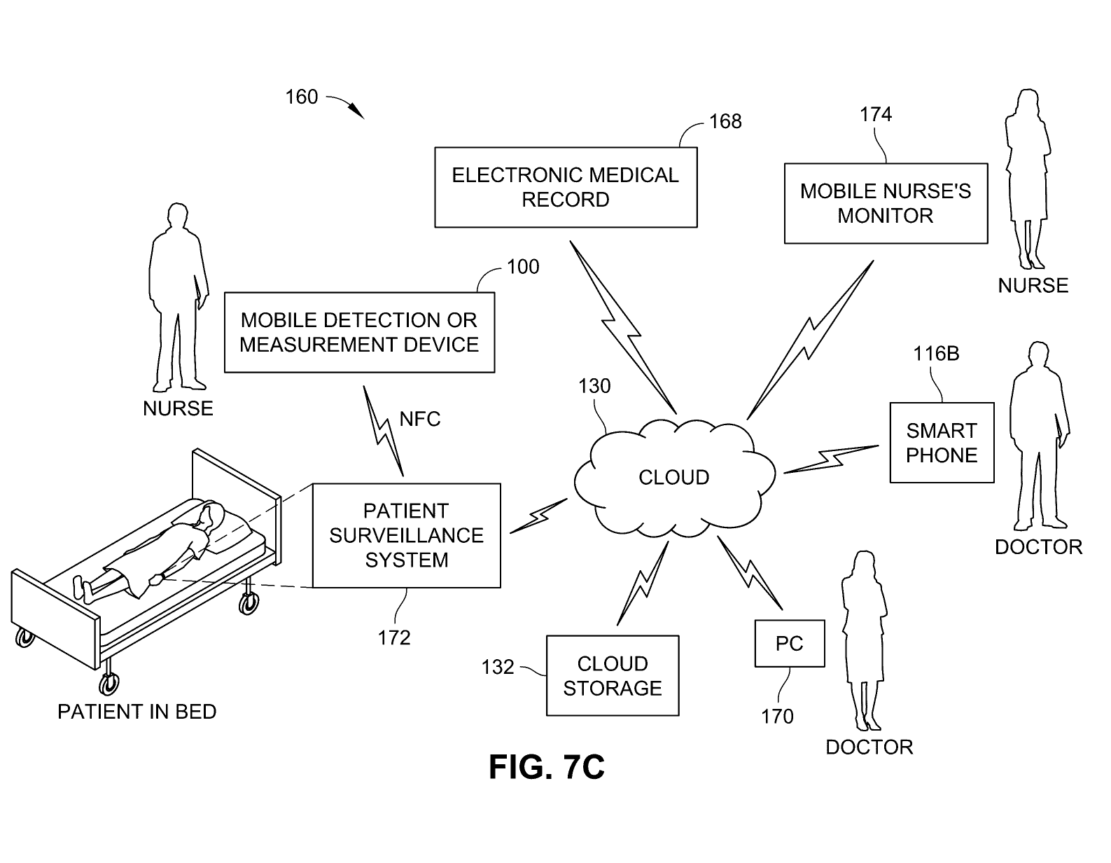

An example embodiment of a cloud computing environment 150 is shown in FIG. 7A. As shown, the network 130 can comprise a cloud computing network that implements a multi-user, multi-device, collaborative patient medical record management platform accessible by a patient device 116A (e.g., personal computer, mobile device, etc.) and two or more care provider devices 116B and 116C (e.g., personal computer, mobile device, etc.). In some embodiments, the care providers can have different professions, differing specialties, and/or practice at different care providing organizations (e.g., different health care organizations). In this regard, the system is cross-organizational.

FIGS. 7B and 7C further illustrate the collaborative platform that can be implemented by the cloud computing network 130. For example, FIGS. 7B and 7C show an example health care environment 160, where a mobile electronic device 116 or a personal health monitoring device 164 (e.g., such as a MedWand device or the like) can communicate with a desktop computer 166 or directly with the cloud computing network 130 via the Internet. The cloud computing network can also facilitate connectivity between the devices and an electronic medical record system 168, a laboratory information system 162, cloud storage 132, and other computing devices (e.g., a doctor or other care provider's personal computer 170, mobile device, etc.). For example, the electronic medical record system 168 can be accessed by another computer 170 (e.g., at a hospital or other health care provider entity).

In some implementations, a patient can perform a blood or other body fluid/gas test on herself using a mobile measurement or detection device 100 (e.g., as shown in FIG. 7B). The test information can be collected by a mobile electronic device 116 and/or a personal health monitoring device 164 via NFC coupling or the like. The information can then be stored in the cloud storage 132, electronic medical record system 168, or at one or more other computers (e.g., lab information system 162, a health care provider PC 170, etc.). The information can also be displayed at one or more devices connected to the cloud computing network 130.

FIG. 7C shows another example implementation where a nurse can perform a blood or other body fluid/gas test on a patient using a mobile measurement or detection device 100. The test information can be collected by a mobile electronic device 116 and/or a patient surveillance system 172 (e.g., a wearable health monitor, such as the ViSi Mobile System by Sotera Wireless) via NFC coupling or the like. The information can then be stored in the cloud storage 132, electronic medical record system 168, or at one or more other computers (e.g., lab information system 162, a health care provider PC 170, nurse station computer, etc.). The information can also be displayed at one or more devices connected to the cloud computing network 130, for example, the information can be stored and/or viewed at a health care provider's mobile electronic device 116B, a nurse's mobile electronic device 174, or any other stationary or mobile device or monitoring system.

In some implementations, the mobile electronic device 116 is configured to communicate with a patient surveillance system 172 (e.g., a wearable health monitor, such as the ViSi Mobile System by Sotera Wireless, or the like). For example, the mobile electronic device 116 may communicate a patients vitals that are collected by the patient surveillance system 172 to the cloud computing network 130. In this manner, the vitals and/or measurements from the mobile measurement or detection device 100 can be uploaded to the electronic medical record system 168 or another cloud-based patient medical record management platform, for later access by medical professionals, other health care providers, or the patient.

In some embodiments, the multi-user, multi-device, collaborative patient medical record management platform selectively provides access to patient history, test results, treatments, diagnostics, demographics and patient identity information stored by the cloud computing network 130. In some embodiments, patient identity information can be removed from the other data to provide useful statistical information, analysis, or geographic/demographic trends. For example, the multi-user, multi-device, collaborative patient medical record management platform can be configured to selectively provide access to one or more of the test results, treatments, diagnostics, and demographics stored by the cloud computing network 130, dissociated from the patient identity information; or the multi-user, multi-device, collaborative patient medical record management platform may selectively provide access to analysis or trends based upon one or more of the test results, treatments, diagnostics, and demographics stored by the cloud computing network 130.

In some embodiments, the cloud computing network 130 and/or the mobile electronic device 116 is further configured to store contextual information regarding the mobile measurement or detection device 100. For example, when the mobile measurement or detection device 100 is used to perform analysis on a sample, contextual information such as time, date, and/or location can be stored (e.g., as metadata) with the measurement or detection information.

In some embodiments, the cloud computing network 130 and/or the mobile electronic device 116 can be configured to track an inventory of mobile measurement or detection devices 100, where an inventory count is reduced when one of the mobile measurement or detection devices 100 is used. The cloud computing network 130 may provide an alert (e.g., via the mobile electronic device 116), an option to order more mobile measurement or detection devices 100, or may be configured to communicate an automated order (e.g., to the supplier) when the inventory count is reduced below a threshold inventory of mobile measurement or detection devices 100.

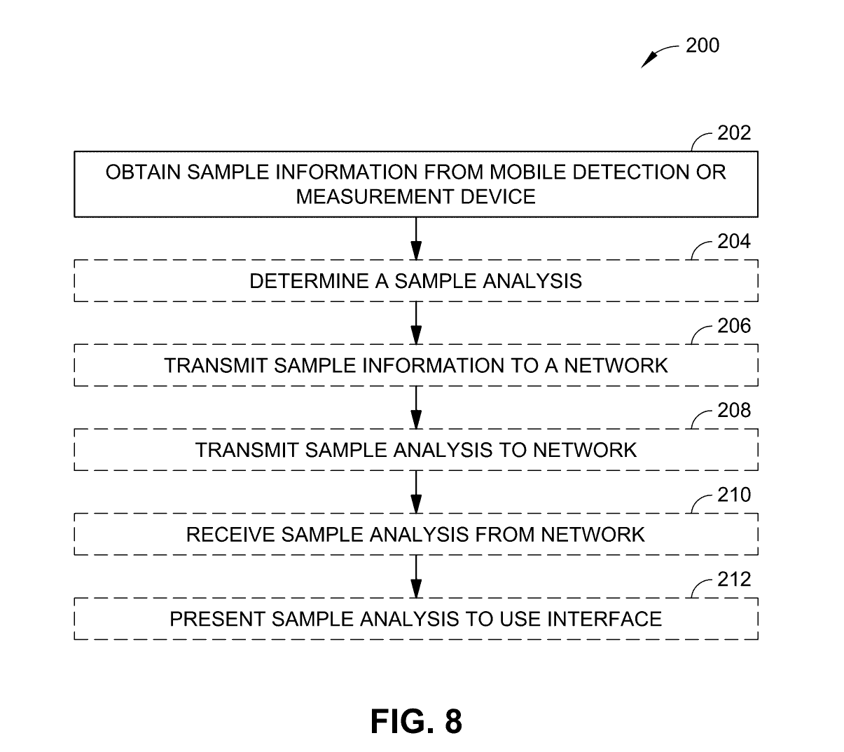

The following discussion describes example techniques for using a mobile electronic device 116 and/or a mobile detection or measurement device 100 for providing a sample analysis, such as the mobile electronic device 116 and the mobile detection or measurement device 100 (e.g., as shown in FIGS. 1 through 7C). FIG. 8 depicts an example process 200 for using a mobile sample analysis system 114, which can include the mobile electronic device 116 and/or a mobile detection or measurement device 100, to provide a sample analysis.

As shown in FIG. 8, sample information is obtained at a mobile detection or measurement device (Block 202). In some implementations, receiving sample information can include using a mobile detection or measurement device 100 and/or the sensor module 104 to collect, for example, a biological fluid sample, gather biological fluid sample information, and/or provide the biological fluid sample information to a mobile electronic device 116 (using short-range wireless communication transceiver 106), which receives the biological fluid sample information. For example, a mobile detection or measurement device 100 can include a blood test device, which can be used to collect a blood sample from a patient (e.g., a finger 110). The mobile detection or measurement device 100 can collect the blood sample, which can contact the sensor module 104 that can obtain and/or store blood sample information (e.g., using a chemical analysis or other analysis) that can further be transmitted and/or provided to and received by a mobile electronic device 116 (e.g., a smartphone). Using a mobile electronic device 116 can include using a controller 122 to activate short-range wireless communication 118 when the mobile detection or measurement device 100 is disposed proximate to the mobile electronic device 116. In another example embodiment, receiving the sample information may include concurrently transmitting power from a mobile electronic device 116 to a mobile detection or measurement device 100, for example, using near-field techniques, such as a magnetic field and/or inductive coupling.

In some implementations, a sample analysis is determined (Block 204). In some embodiments, determining a sample analysis can include using a mobile electronic device 116 to determine a biological fluid analysis. For example, mobile electronic device 116 can use a controller 122 to determine a biological fluid analysis using received biological fluid sample information. In some implementations, the controller 122 can determine the sample and/or biological fluid analysis by using raw biological fluid sample information (e.g., data including blood components, urine components, other biological fluid components, a specific signal obtained by module 104, etc.) and processing the raw data to determine, calculate, and/or formulate the biological fluid analysis. Some examples of a biological fluid analysis may include a urinalysis, a blood glucose test, a cholesterol test, a DNA test, and/or a drug test. It is contemplated that other types of sample analyses may be determined using a mobile electronic device 116 and/or a controller 122, such as a solid material analysis and/or a gas analysis.

In some implementations, sample information is transmitted to a network using a mobile electronic device (Block 206). In some implementations, transmitting sample information can include using a mobile electronic device 116 to transmit biological fluid sample information (e.g., raw information that has not been processed) to a network 130. Some examples of a network 130 can include a wireless network (e.g., a cloud network, a cellular network, the Internet, an internet, etc.), which the mobile electronic device 116 can connect with using, for example, Wifi, Bluetooth, and/or cellular technology. In these implementations, a computing device in network 130 (e.g., a remote server, which can include cloud storage 132) can determine a sample analysis.

In some implementations, a sample analysis is transmitted to a network using a mobile electronic device (Block 208). Transmitting a sample analysis to a network 130 can include using a mobile electronic device 116 to transmit a sample analysis (determined by a controller 122) to a network 130. In these implementations, the sample analysis can be stored (e.g., by cloud storage 132), further processed, and/or presented to another device (e.g., a virtual health vault, a medical provider, etc.), which may be communicatively coupled to network 130.

In some implementations, a sample analysis is received from a network using a mobile electronic device (Block 210). In these implementations, receiving a sample analysis from a network 130 (e.g., cloud network, the Internet) may include receiving a sample analysis that has been determined using a network computing device 134 (e.g., a server) at least partially based on sample information previously transmitted by mobile electronic device 116 and obtained from a mobile detection or measurement device 100.

Then, a sample analysis is presented to a user interface (Block 212). In some implementations, presenting a sample analysis can include presenting the sample analysis to a user interface 120, such as a touchscreen of a mobile electronic device 116. In another implementation, presenting a sample analysis can include presenting the sample analysis to a network user interface 136 including a display connected to a network computing device 134. Some examples of a network user interface 136 can include a display connected to an Internet connected server, a display connected to an online virtual health database, etc.

In some implementations, providing a sample analysis, a mobile electronic device 116 can receive, via a near field communication interface, biological fluid sample information including information regarding a patient's blood (e.g., amount of cholesterol) collected by a mobile detection or measurement device 100. In such an implementation, the biological fluid sample information can be transmitted by a mobile electronic device 116 including a smartphone using a cellular data network to network 130 (which may include the cellular data network) including the Internet. The biological fluid sample information can then be processed by a network computing device 134 including a server configured with means for determining a biological fluid analysis. The biological fluid analysis can then be transmitted from the network computing device 134 via the Internet to the mobile electronic device 116 and presented to user interface 120 (e.g., screen) for viewing by a user (e.g., patient).

In implementations, to provide a biological fluid analysis, a mobile electronic device 116 can receive, via near field communication, biological fluid sample information including information regarding a patient's urine (e.g., amount of glucose) collected by a mobile detection or measurement device 100. The mobile electronic device 116 and/or controller 122 can process the biological fluid sample information to determine and/or formulate a biological fluid analysis (e.g., a urinalysis). The biological fluid analysis can then be presented to the user interface 120 (e.g., screen). In implementations, the biological fluid analysis data/measurement(s) 138 (e.g., such as the data/measurement(s) shown in FIG. 5) can be further transmitted from the mobile electronic device 116 to a network 130, a network computing device 134, and/or cloud storage 132 via the Internet for further processing and/or utilization.

Example Implementations of a Mobile Measurement/Detection Device

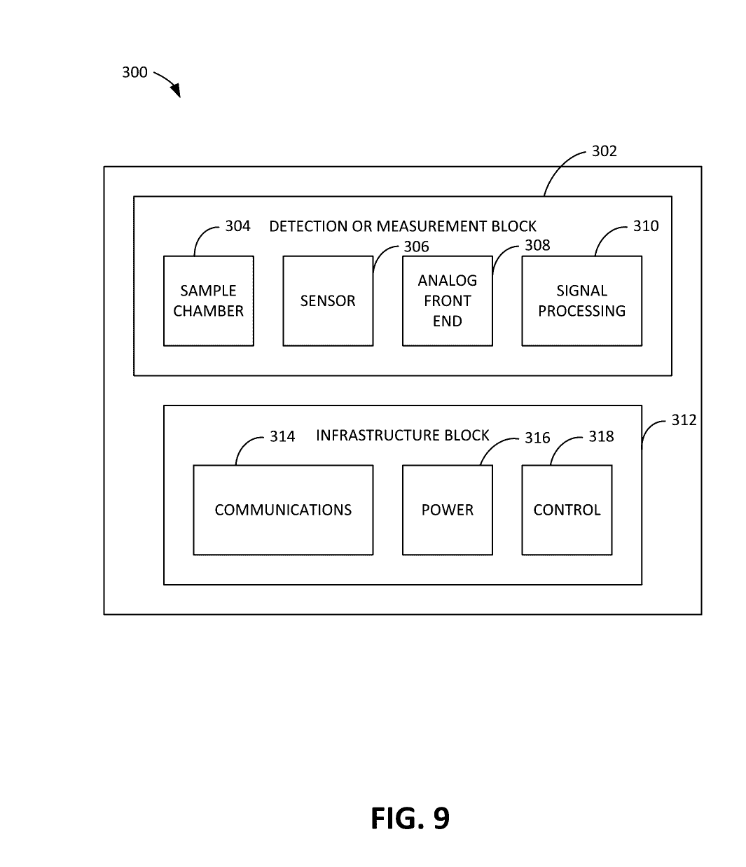

FIGS. 9 through 14 illustrate various embodiments of a mobile detection or measurement device 300 (e.g., such as the mobile detection or measurement device 100 previously described herein). As shown in FIG. 9, the measurement or detection device 300 can include circuitry blocks or hardware modules for measurement or detection, communications, control, and/or power. For example, the measurement or detection device 300 can include a detection or measurement block 302 and a power and communications infrastructure block 312. In some embodiments, the detection or measurement block 302 includes a sample chamber 304 configured to receive a fluid (e.g., gas or liquid) sample via capillary action, microfluidics, syringe or syringe-like pressure (e.g., negative vacuum pressure), or the like. At least one sensor 306 (e.g., electrochemical sensor, chemiresistive sensor, electric-field sensor, magnetic-field sensor, optical sensor, or the like) can be coupled to the sample chamber 304. In other embodiments, the sensor 306 can have an exposed sensor area that directly receives fluid placed into contact therewith. The sensor 306 is configured to generate one or more electrical signals corresponding to one or more target analytes which may be present in the fluid sample.

In embodiments, the measurement or detection block 302 may include analog front end pre-processing circuitry 308 (e.g., low pass, band pass, or high pass filter(s), analog-to-digital converter (ADC), and so forth) in series with signal processor 310 (e.g., microcontroller, microprocessor, FPGA, ASIC, or the like). The signal processor 310 (and in some embodiments, pre-processing circuitry 308) can filter out noise and calculate the measurement result that can then be communicated to the mobile device 116 (e.g., smartphone, tablet, notebook, media player, etc.), a desktop computer, or the like.

A communications interface 314 can include a low power, short-range communications device, such as a near-field communications (NFC) transmitter or transceiver. In some embodiments, the communications interface 314 includes or is coupled to power management circuitry 316 and/or a controller 318 (e.g., micro-controller/processor or the like). The power management circuitry 316 can include a power harvesting circuit that harvests inductively transferred power (e.g., power transferred via NFC or the like); or in some embodiments, the power management circuitry 316 can additionally or alternatively include a local energy source (e.g., a battery, capacitor, photovoltaic cell, or the like). The controller 318 can control communication of data or signals associated with the electrical signals output by the sensor 306. For example, the control circuitry can receive data or signals from the signal processor 310 and transmit the data or signals to the mobile device via the communications interface 314, which may be coupled to an antenna for wireless communication. The controller 318 can also control the power management circuitry 316. In some implementations, the controller 318 communicates with or activates the sensor 306 and/or provides data or signals to the mobile device in response to communications and/or power signals received from the mobile device.

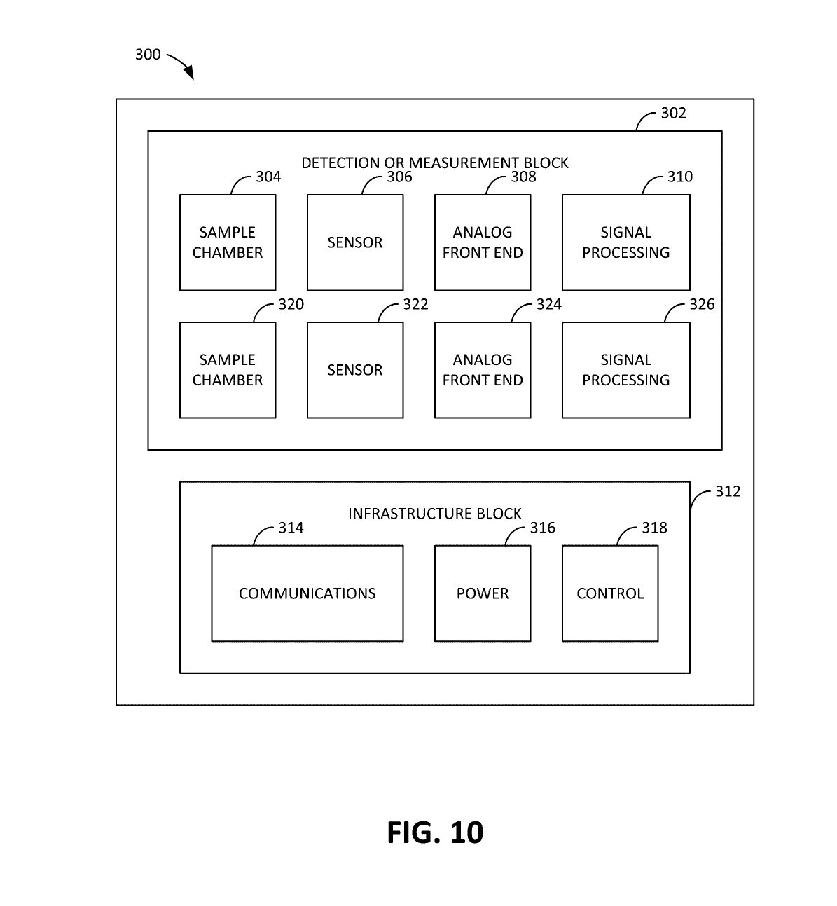

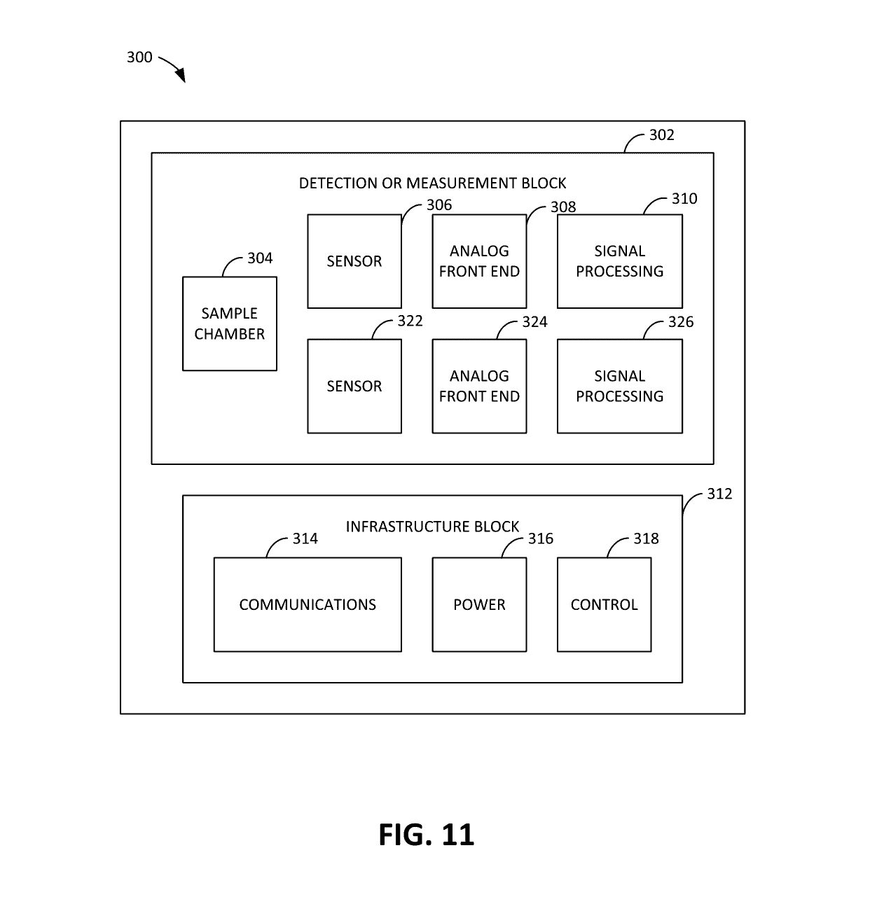

Additional embodiments of the measurement or detection device 300 are shown in FIGS. 10 and 11. As shown in FIG. 10, the measurement or detection device 300 can include at least one additional sample chamber 320, sensor 322, and associated circuitry (e.g., pre-processing circuitry 324, signal processor 326, etc.), and so forth. The second sample chamber 320 and associated components can be used to detect or measure additional (different) target analytes or extend the measurement range of a single analyte. For example, the second sensor 322 generates electrical signals when a second target analyte (different from the analyte triggering the first sensor 306) is present in the sampled fluid. In some embodiments, the second sensor 322 is tuned to detect or tuned to better detect a different concentration range than the first sensor 306. For example, the second sensor 322 may generate electrical signals as a result of a chemical reaction optimized for a different concentration range than that of the first sensor 306. In some embodiments, the sensors 306 and 322 are tuned to detect different concentration ranges of the same analyte. In an example implementation, where a quantitative result is desired over a range of a 1000:1, the sensor can include four sensor windows on a chip—each window can be optimized for a certain concentration magnitude of analyte. The measurement results collected by the individual sensor windows can then be stitched together for a comprehensive result. In some embodiments, the first sensor 306 and the second sensor 322 are coupled to one sample chamber 304 (e.g., as shown in FIG. 11). Any number of sample chambers and/or sensors can be implemented without departing from the scope of this disclosure.

In some embodiments, the measurement or detection device 300 is configured to reject bad samples through the use of secondary sensors to detect negative conditions that may cause errors in the analyte measurement (e.g., using temperature detectors, light detectors, E-field detectors, H-field detectors, moisture detectors, and/or any other additional sensor that measures environmental or sample conditions). For example, the measurement or detection device 300 can be configured to reject sensor measurements associated with blood samples having too much hemolysis, coagulation, or air bubbles.

A plurality of measurements can be taken and averaged to collect more accurate measurement of an analyte. In some embodiments, accuracy is also improved by comparing data collected for one analyte with additional measurements performed for other analytes. For example, the measurement accuracy might be improved by measuring the hematocrit in the blood and then adjusting the final analyte measurement result. Likewise, for hemolysis less than the rejection threshold, the hemolysis measurement might also be used to adjust the final analyte measurement result.

The components of the measurement or detection device 300 are integrated or incorporated into a single-substrate integrated laboratory. This may or may not include a display and perhaps some post-measurement/detection signal or data processing modules, which can instead be implemented by the computing device (e.g., mobile device or PC) in communication with the measurement or detection device 300. For example, the components described above can be mounted to a single substrate and/or contained by a common encasement or cap structure. After the measurement signals or data are transmitted to the mobile device, the measurement data and/or associated information can be stored in non-volatile memory of the mobile device or uploaded/downloaded or otherwise transferred to a personal computer (PC), notebook, tablet, second mobile electronic device, flash drive, external storage, cloud computing network, server, or the like. In some embodiments, a cloud computing network provides a user interface and data processing or storage services via an application interface that is run on the mobile device. In other embodiments, the mobile device or another device (e.g., a personal computer (PC), notebook, tablet, second mobile electronic device, etc.) processes the collected data, stores the data in a library, and/or transfers the collected data or associated data to a health monitoring center. The mobile device can also provide user feedback based on preprogrammed responses or communications received from a server (e.g., health monitoring center server), cloud computing network, or secondary device (e.g., PC running health monitoring software).

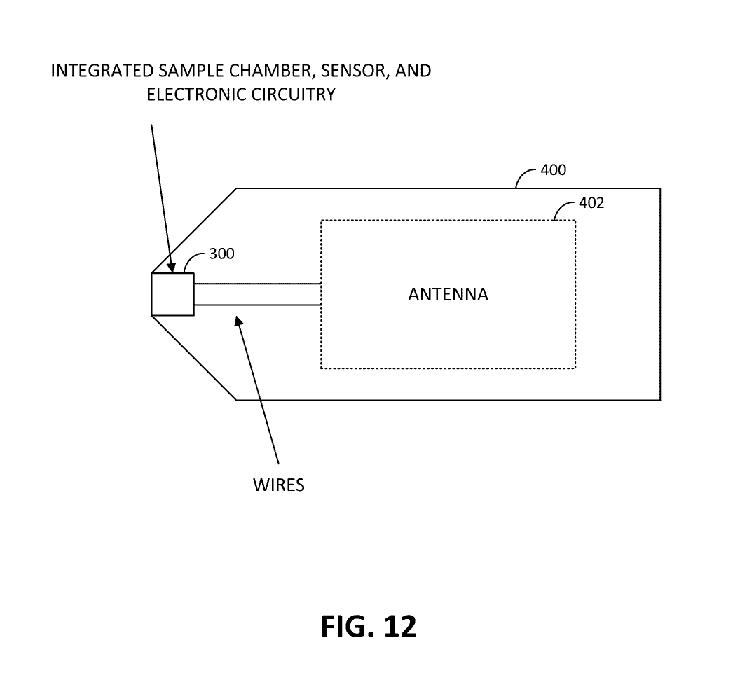

FIG. 12 shows an embodiment of the measurement or detection device 300 implemented into single-substrate integrated laboratory device 400 (e.g., integrated into a single-use or limited-use device including a single substrate that implements the measurement or detection device 300). In some embodiments, the single-substrate integrated laboratory device 400 shown in FIG. 12 can implement the mobile measurement or detection device 100 previously described herein. For example, the integrated measurement or detection device 300 can implement the sensor module 104 of the mobile measurement or detection device 100. Device 400 can include the measurement or detection device 300 hardware implemented as a single-substrate integrated laboratory and an antenna 402 (e.g., like antenna 106) coupled to the measurement or detection device 300 for wireless communication and/or power transfer. The measurement or detection device 300 can be used to: collect a fluid sample (e.g., biological liquid/gas sample, or other liquid/gas sample); wirelessly communicate data or information signals to a mobile device, PC, or the like, wherein the data or information signals correspond to target analytes measured or detected by the sensor 306 (or multiple sensors); and afterwards, the single-substrate integrated laboratory device 400 (including the measurement or detection device 300) can be disposed of, while the measurement data is saved to the mobile device or sent to a server, uploaded to a cloud computing network, transferred to another device, or the like.

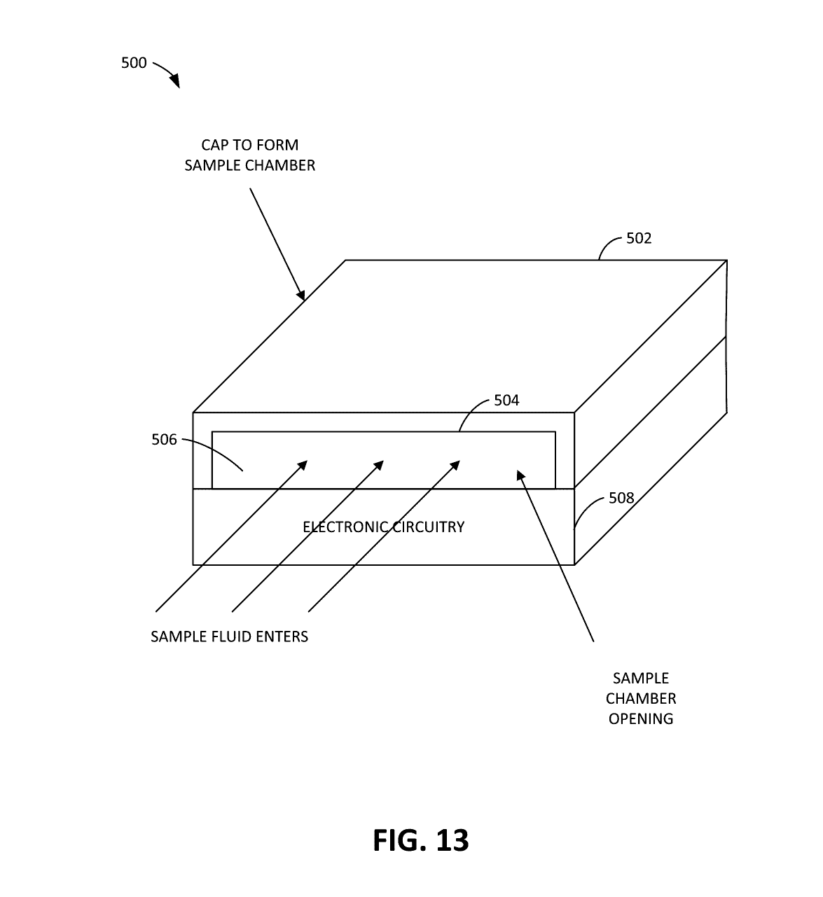

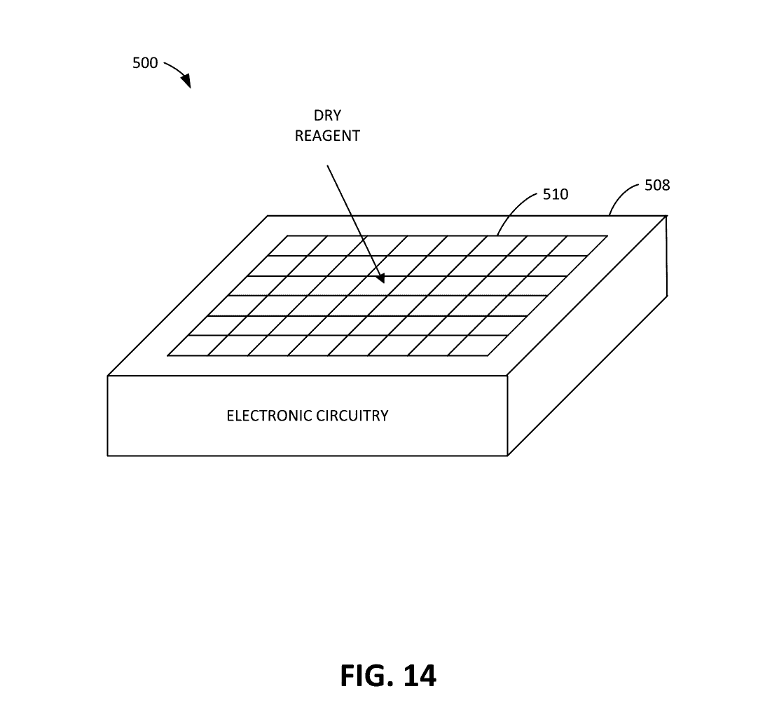

FIGS. 13 and 14 show an example of a measurement or detection device 500, such as the measurement or detection device 300 described herein, constructed in accordance with an embodiment of this disclosure. As shown in FIG. 13, the measurement or detection device 500 can include a substrate 508 with electronic circuitry (e.g., such as sensor 306 and associated circuitry and/or other measurement or detection device components) mounted thereon. A cap or encasement 502 can at least partially surround and/or may be coupled with the substrate 508, where a sample chamber 504 (e.g., like sample chamber 304) is located between the substrate 508 and the cap or encasement 502. In some embodiments, the cap or encasement 502 includes the sample chamber 504 or interface between the substrate 508 and the cap, or encasement 502 defines the sample chamber 504. The cap or encasement 502 can include one or more openings 506 for fluid to enter the sample chamber 504 (e.g., due to capillary action, as a result of applied negative pressure, or the like). In embodiments, the sample chamber 504 defines a known volume to allow for measurement target analyte concentration (e.g., the number or amount of target analyte per a given volume).

As shown in FIG. 14, the substrate 508 may have a dry reagent 510 deposited thereon, or in some embodiments, the dry reagent can be deposited on an inner surface of the cap or encasement 502. The dry reagent 510 may dissolve in the fluid sample and can be reactive with one or more target analytes in the fluid sample, wherein said reaction causes the sensor (e.g., sensor 306) to generate one or more corresponding electrical signals. The dry reagent 510 can include enzymes, beads, functionalized superparamagnetic nanoparticles, or any substance reactive with the one or more target analytes in the fluid sample. The measurement or detection device 500 can include hardware as described above with regards to measurement or detection device 300, and can wirelessly transmit (e.g., via communications interface 314) data or information signals associated with the measurement/detection signals generated by the sensor (i.e., measurements or readings associated with the one or more target analytes).

While a chemistry-based sensor implementation is described above, additional sensor implementations are contemplated. For example, as described below, embodiments of the mobile measurement or detection device 100 can include an electric-field sensor/imager, a magnetic-field sensor/imager, an optical sensor/imager, or a multi-modal sensor/imager that comprises two or more of the foregoing sensor types, and possibly others. In some embodiments, one or more of the sensors/imagers described below can be implemented in the sensor module 104 of the mobile measurement or detection device 100. In other embodiments, one or more of the sensors/imagers described below can be implemented as stand-alone devices or built into the architecture of the mobile electronic device 116.

Additional Sensor Implementations—Electric-Field Imager

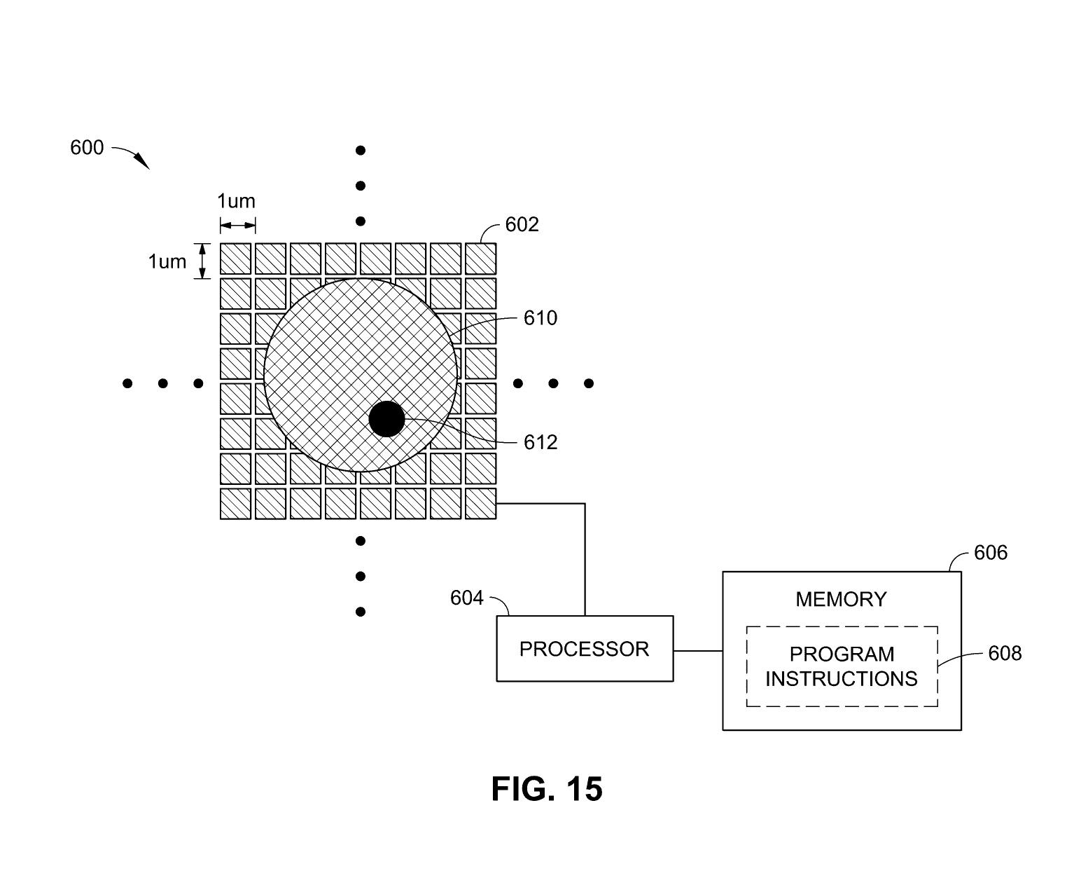

FIGS. 15 through 18 illustrate an electric-field imager 600 in accordance with various embodiments of this disclosure. In an embodiment illustrated in FIG. 15, the electric-field imager 600 is shown to include a plurality of conductive metal panels 602 making up the pixels of an active sensor area. In some implementations, the metal layer of an integrated circuit can form the electric field sensor array. The active sensor area can receive a fluid sample including target analytes (e.g., hormones, proteins, viruses, prions, sperm, cells, beads, biological microparticles, etc.), which can be deposited over the active sensor area for electric-field imaging based on changes in impedance or charge detected at respective ones of the metal panels 602. For example, FIG. 15 shows a cell 610 on the active sensor area, where the sensor pitch may be appropriate for imaging the cell 610 and various cellular structures (e.g., the cell's nucleus 612). A sensor pitch in the range of lum is shown in FIG. 15; however, it is noted that the sensor pitch can be larger or smaller to suit different applications. In some embodiments, the pitch is anywhere from approximately 10 nm to 20 um. To properly image individual target analytes (e.g., individual cells or microparticles of interest), the sensor pitch may be higher frequency than a Nyquist spatial sampling rate suitable for detecting a smallest member of a group of target analytes. In some implementations, detection of cellular structures or morphology can be used to distinguish between different types of biological cells (e.g., white blood cells vs. red blood cells).

The electric-field imager 600 can include transmitter circuitry configured to generate drive signals that are applied to one or more of the metal panels 602 or applied to a driving electrode positioned relative to the panels 602. In some embodiments, the transmitter can include a frequency generator that feeds into one or more digital to analog converters (DACs) to generate one or more drive signals. The electric-field imager 600 can also include receiver circuitry coupled to the metal panels 602, and configured to sense changes in impedance or charge detected by the metal panels 602. In some embodiments, the receiver can include one or more analog to digital converters (ADCs) configured to receive an impedance, voltage, or current reading from each of the metal panels 602 to sense changes in impedance or charge, which can result from the presence of target analytes in proximity of one or more of the metal panels 602. In some embodiments, the receiver circuitry can also include a frontend filter (e.g., low pass filter) configured to remove noise or signal components attributable to the fluid containing the target analytes, drive signal artifacts, and so forth.

The electric-field imager 600 may further include processing logic embodied by a programmable logic device, a controller/microcontroller, a single or multiple core processor, an ASIC, or the like. For example, the electric-field imager 600 can include a processor 604 coupled to a memory 606 (e.g., solid-state disk, hard disk drive, flash memory, etc.), where the memory includes program instructions 608, such as one or more software modules executable by the processor 604. In some embodiments, the processing logic can control transmission and receipt of signals to and from the metal panels 602. For example, the processing logic may be coupled with receiver and/or transmitter circuitry. The processing logic may be configured to generate an image based on electrical signals associated with changes in impedance or charge detected at one or more of the metal panels 602. In some embodiments, the processing logic can include fast Fourier transform (FFT) and impedance sense algorithms. The processing logic can further include one or more computer imaging software modules executable by a processor/controller to identify attributes of target analytes in the generated electric-field image. For example, the computer imaging modules may cause the processor/controller to perform a comparison between one or more portions of the generated electric-field image and a library with stored images or data associated with one or more attributes, such as size, type, morphology, distribution, concentration, number of cells/microparticles, and so forth.

In some embodiments, the electric-field imager 600 can include multiple-sensor areas or regions with different sensor pitches/dimensions for targeting smaller particles (e.g., microparticles) vs. larger particles (e.g., cells). For example, a first area with larger sensor pitch can be used to image cells or larger particles. This can be useful in cases where smaller particles are not of interest and/or cases where speed is more important than resolution. On the other hand, a second area with finer sensor pitch can be used to collect higher resolution electric-field images and detect microparticles and/or resolve cellular structures. At finer resolutions, both large and small particles may be detected.

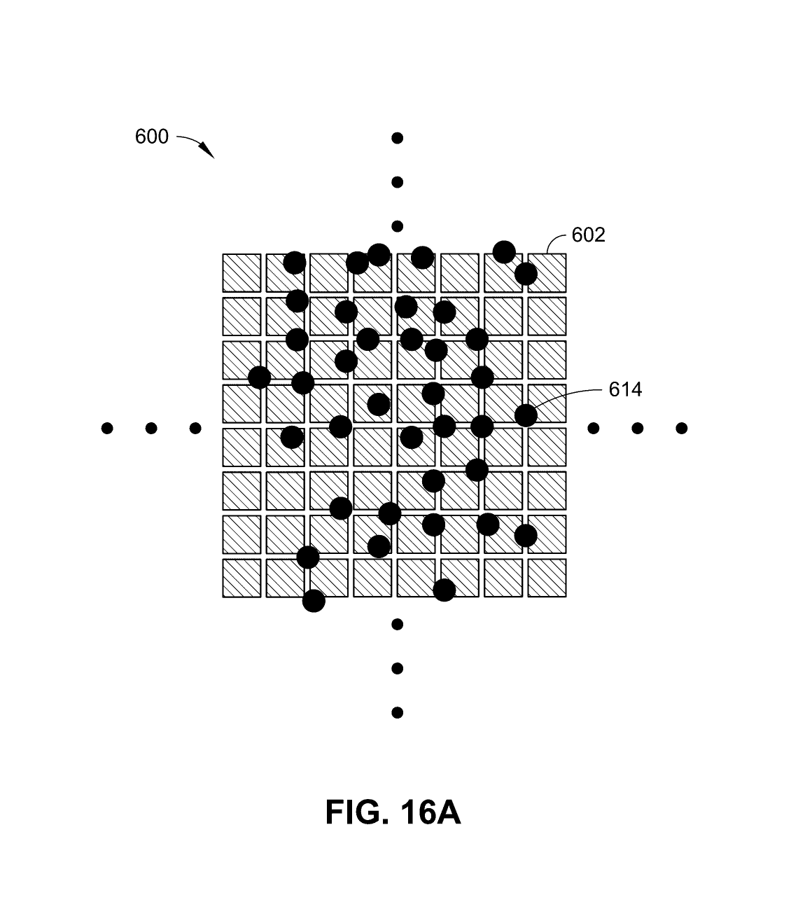

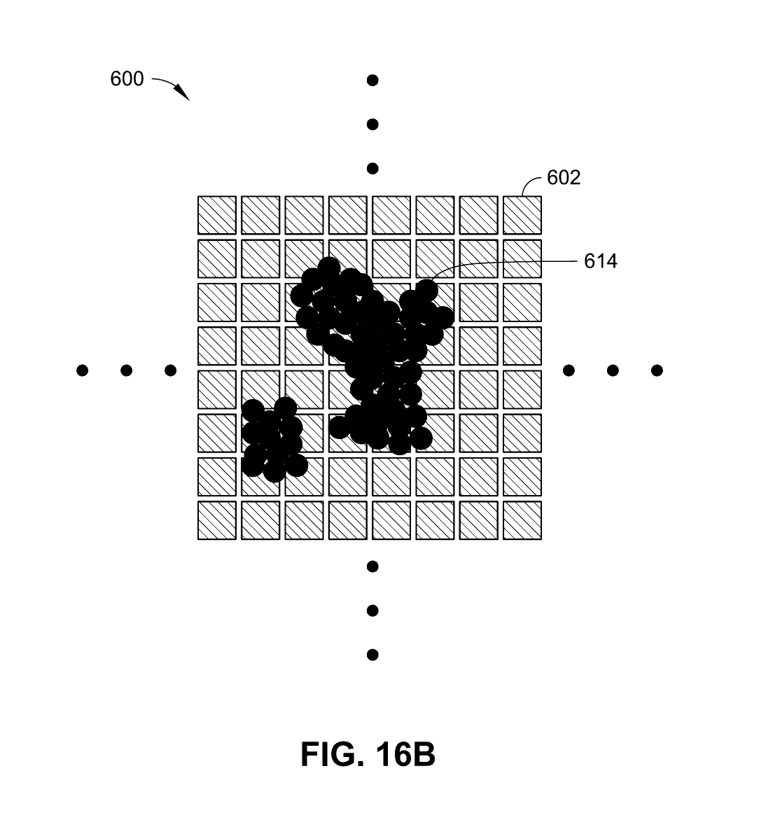

In some embodiments, the electric-field imager 600 can be configured to collect multiple electric-field images taken at different times (e.g., time lapsed images) to monitor growth or movement of cells/microparticles. For example, time lapsed images can be used to monitor cells as they multiply or for agglutination assaying to monitor movement of dispersed particles (e.g., antibody-coated microbeads 614 shown in FIG. 16A) as they agglutinate in the presence of an antigen (e.g., as shown in FIG. 16B). The electric-field imager 600 can be configured to perform agglutination or agglomeration assays including, but are not limited to, immunoassays, kinetic agglutination assays, agglomeration-of-beads assays, kinetic agglomeration-of-beads assays, coagulation assays, kinetic coagulation assays, surface antigen assays, receptor assays from biopsy procedures, circulating blood cells assays, and/or circulating nucleic acid assays (see, e.g., Michael Fleischhacker et al., Circulating nucleic AIDS (CNAs) and cancer A survey, Biochimica et Biophysica Acta (February 2007)). For example, the electric-field imager 600 can have an active sensor area with a sensor pitch that is higher frequency than a Nyquist spatial sampling rate suitable for detecting a smallest member of a group of one or more target analytes (e.g., beads, cells, etc.) in the fluid sample for the assay being performed.

Applications of functionalized bead technology for the electric-field imager 600 and diagnostics mainly apply to immunoassays, but can apply to other agglutination/agglomeration assays as well. There are hundreds of analyses that can be tested in this field. Functionalized beads may also be useful in coagulation assays as image enhancers if red blood cells are difficult to resolve. For example, instead of relying solely on the red blood cells, the electric-field imager 600 can image the movement of beads along with the red blood cells as a clot is forming. Beads can also be used as internal standards to help verify object sizes (e.g., size of blood cells when doing complete blood counts) because the beads are manufactured with a known size (e.g., known diameter or diameter within known range). Beads used for electric-field imaging applications can include, but are not limited to: plastic (e.g., PolyStyrene (PS)) beads with, sizes (diameter) ranging from 50 nm to 13 μm; PS coated beads, sizes (diameter) ranging from 40 nm to 5 μm; PS coated beads, sizes (diameter) ranging from 5 um to 35 μm; ferromagnetic beads (e.g., chromium dioxide coated PS beads), sizes (diameter) ranging from 2 μm to 120 μm; paramagnetic beads (e.g., magnetite coated PS beads, possibly with variety of coatings), sizes (diameter) ranging from 100 nm to 120 μm; gold or silver colloids (particles/sols), sizes (diameter) ranging from 2 nm to 250 nm; or other commercially available beads.

The range in size for any one bead size supplied is typically 10% to 20% of the mean size. Typically, the more narrow this range the more expensive the product will be. Plastic beads may have more of an effect on the electric field, so they should be easier to resolve than red blood cells or other biological cells. Metal-containing beads may have even more of an effect on the electric field, so they should be even easier to resolve than plastic beads. Magnetic beads are useful for separation, which may have specific applications for the electric-field imager 600, for example, for tracking growth or movement of a particular cell type with respect to others, where the monitored cells are tagged with magnetic beads for easier separation. Smaller/lighter beads will result in a faster reaction, while larger/heavier beads will result in a slower reaction. However, larger beads can be more easily resolved by the electric-field imager 600. As demonstrated by the foregoing examples, certain bead types and/or sizes will have advantages over other bead types and/or sizes depending on the application and factors being considered (e.g., reaction time vs. resolution, and so forth).

In embodiments, the system can further include a thermal sensor configured to detect a temperature of the fluid sample containing the biological cells or microparticles and/or a conductivity sensor configured to detect a conductivity of the fluid sample or portions thereof. In some implementations, the impedance-based sensor itself (e.g., one or more of the metal panels 602) can be configured to detect the conductivity of the fluid sample or sample conductivity at different regions of the active sensor area.

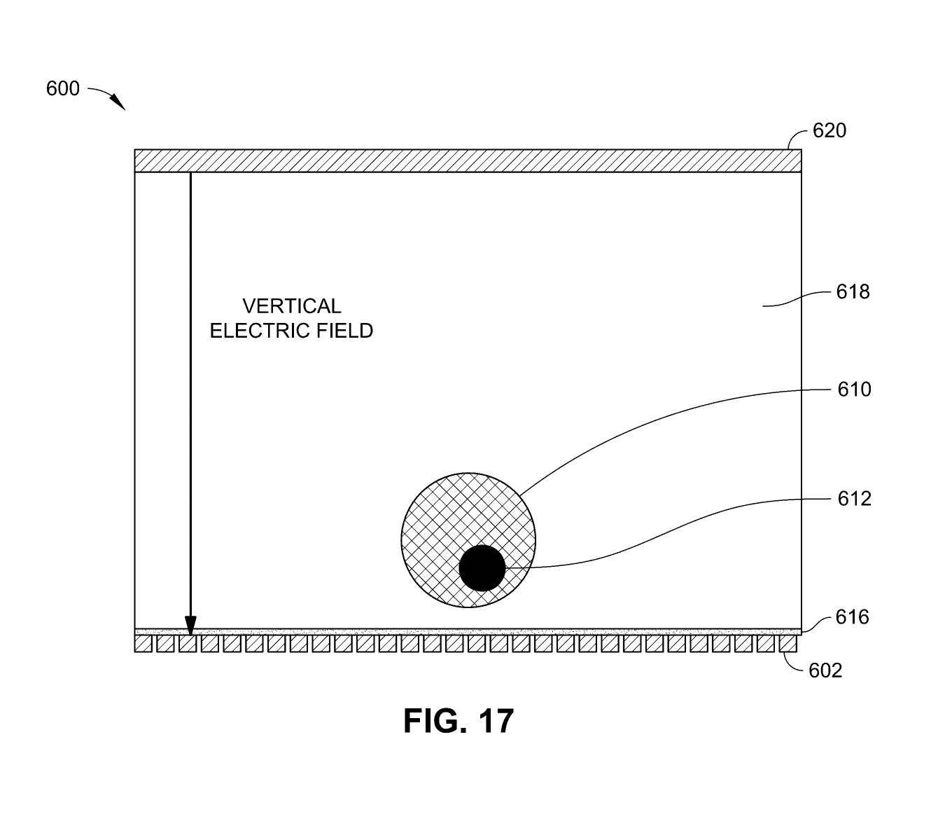

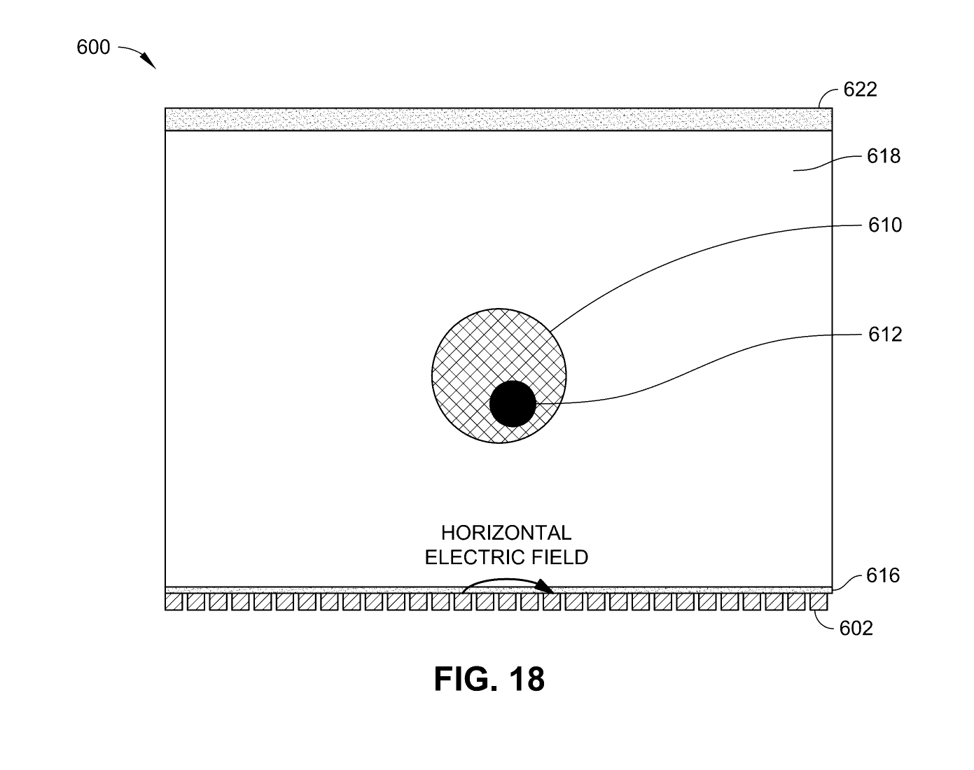

In some embodiments, the electric-field imager 600 relies on a substantially vertical electric field. As shown in FIG. 17, for example, a driving electrode 620 can be located above the electric field sensor array defined by the metal panels 602. In some embodiments, the metal panels 602 are covered by an insulator 616 (e.g., glass or plastic) that separates the metal panels 602 from the fluid 618 containing the target analytes (e.g., cells 610, cellular structures 612, etc.). The driving electrode 620 can induce a vertical electric field that is formed between the driving electrode 620 and the sensor array of metal panels 602 disposed below. The electric-field imager 600 can additionally or alternatively rely on a substantially horizontal electric field. For example, as shown in FIG. 18, a single pixel/panel 602, line of pixels/panels 602, or one or more regions of pixels/panels 602 can be driven, and other ones of the pixels/panels 602 in the electric field image sensor array can detect the electric field generated by the pixels/panels being driven. The presence of analytes like microparticles, viruses, cells, etc., in the fluid disturbs the electric field (e.g., changes in impedance or charge detected from driving pixel/panel 602 to receiving pixel/panel).

In some embodiments, the driving electrode 620 or an insulator 622 (e.g., glass or plastic substrate) is positioned over the fluid sample, such that the fluid sample is sandwiched between the active sensor array and the electrode 620 or insulator 622. Positioning of the electrode 620 or insulator 622 can be used to limit the possible distance between target analytes in the fluid and the metal panels 602 of the sensor array. In some embodiments, the distance is limited to approximately 10 microns or less.

In various embodiments of the present disclosure, the electric-field imager 600 may be at least partially powered by a near-field communications (NFC) device. For example, the mobile electronic device 116 having NFC technology may be positioned proximate to the electric-field imager 600 (e.g., where the electric-field imager 600 is implemented in the sensor module 104 of the mobile detection or measurement device 100). Due to the proximity to the NFC technology of the mobile electronic device 116, the electric-field imager 600 may be at least partially powered by the NFC technology. The mobile electronic device 116 can also communicate with the electric-field imager 600 using NFC or any other short-range wireless communication protocol as discussed herein with regards to various implementations of the mobile sample analysis system 114. In some embodiments, communication and/or power transfer between the electric-field imager 600 and a stationary electronic device/computer can also be implemented with NFC or other short-range wireless communication protocols.

Additional Sensor Implementations—Magnetic-Field Imager

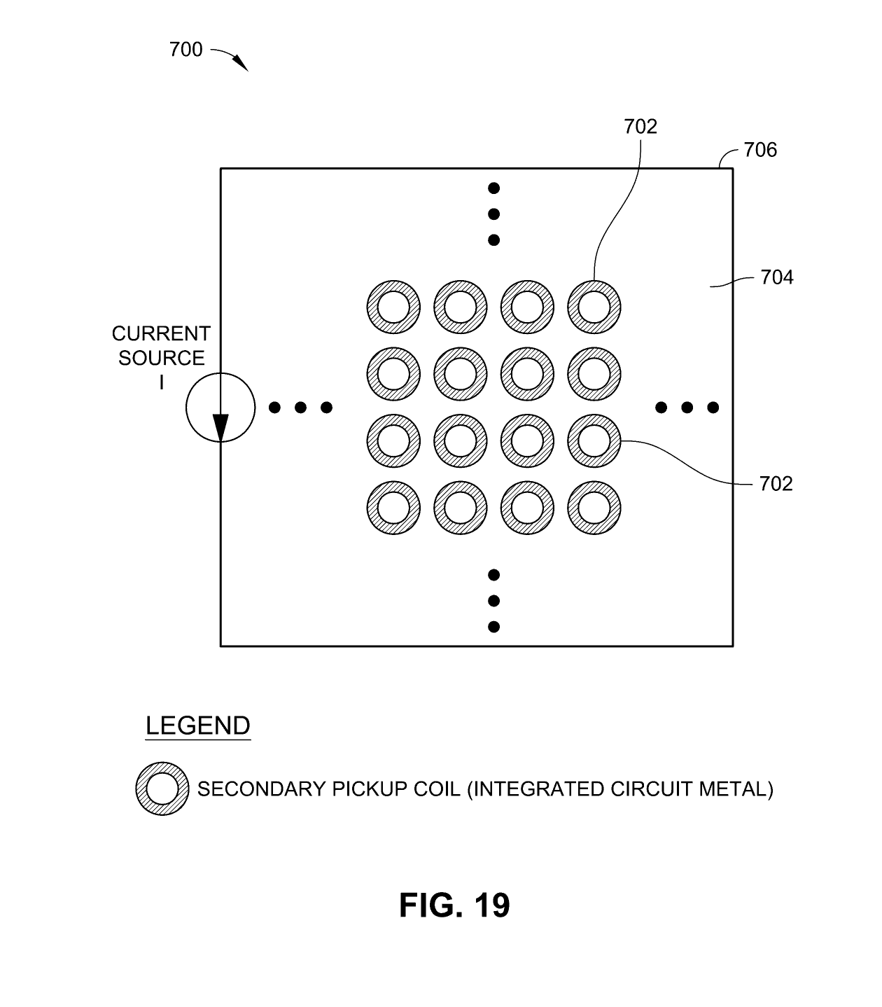

FIG. 19 illustrates a magnetic-field (sometimes referred to herein as an “H-Field”) imager 700 in accordance with various embodiments of this disclosure. In an embodiment illustrated in FIG. 19, the magnetic-field imager 700 is shown to include a plurality of coils 702 (e.g., an array of coils deployed through the magnetic-field imager 700) for detecting changes in magnetic fields. Each coil 702 can define a pixel within the magnetic field image sensor 700. In this manner, the array of coils 702 defines an active sensor area where a fluid sample including cells, viruses, and other entities can be deposited over such that respective coils 702 can detect a change in the magnetic field caused by magnetic nanoparticles or superparamagnetic nanoparticles. In one or more implementations, the pitch between respective coils 702 can vary from 40 nanometers to 100 micrometers.

In embodiments, the magnetic-field imager 700 includes a layer 704 that is utilized to physically separate the cells, viruses, and other entities from the coils 702. In implementations, the layer 704 comprises any suitable material (e.g., an integrated circuit passivation layer, glass panel, or plastic substrate) that allows the coils 702 to detect a change in magnetic field caused by magnetic nanoparticles or superparamagnetic nanoparticles.

As shown in FIG. 19, the magnetic-field imager 700 can include a primary excitation coil 706 disposed about the panel 704. The primary excitation coil 706 causes generation of a magnetic field that is perpendicular to a plane defined by the panel 704 when current flows through the primary excitation coil 706. If magnetic nanoparticles are in the sample, then they will rotate such that their magnetic moments will be aligned parallel to the magnetic field. If superparamagnetic nanoparticles are in the sample, then the magnetic field generated by the primary excitation coil 706 induces magnetism in the superparamagnetic nanoparticles, which align their resulting magnetic moments parallel to the magnetic field. In addition, the magnetic field interacts with the magnetic moment of the magnetic nanoparticles or the superparamagnetic nanoparticles and pulls them to the plane of the magnetic field image sensor.

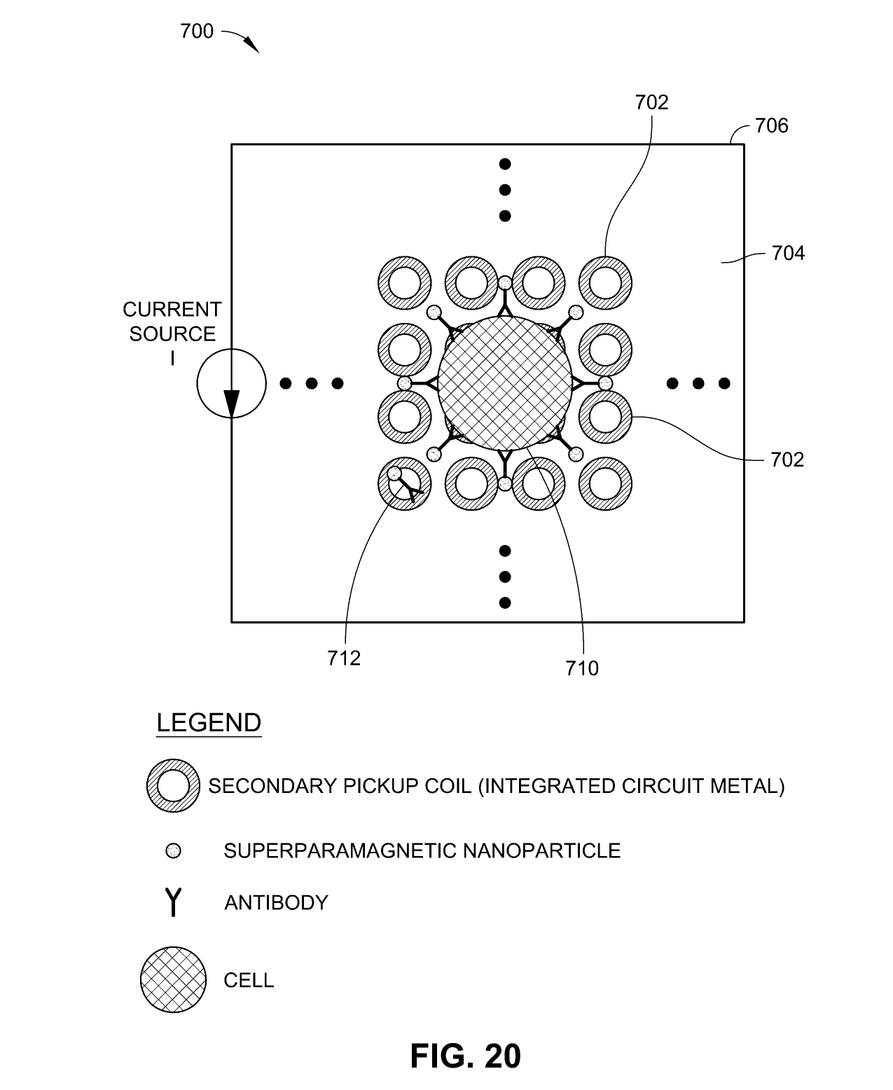

In an implementation shown in FIG. 20, the magnetic-field imager 700 can be used to count the number of cells 710 in a sample. For example, the target cells might be infectious bacteria in whole human blood. Super paramagnetic nanoparticles functionalized with antibodies 712 that bind to structures on the target cell can be mixed into the sample. The super paramagnetic nanoparticles attach to the target cells. Once the primary excitation coil 706 is turned on, then the super paramagnetic nanoparticles align themselves to the primary magnetic field. The nanoparticles are pulled to the image sensor, which senses the presence and amount of nanoparticles on a pixel-by-pixel basis. Target cells have a much higher number of nanoparticles attached to it than can be found elsewhere in the sample. Suitable algorithms can interpret the resulting image frame to determine the number of cells for a given sample volume. For example, the sensor coils 702 can output signals to a communicatively coupled controller (e.g., a micro-processor, micro-controller, ASIC, FPGA, or the like) that is configured to execute the image processing algorithms as program instructions or software modules from a storage medium (e.g., flash memory, solid-state disk, SD card, or the like) that is in communication with the controller.

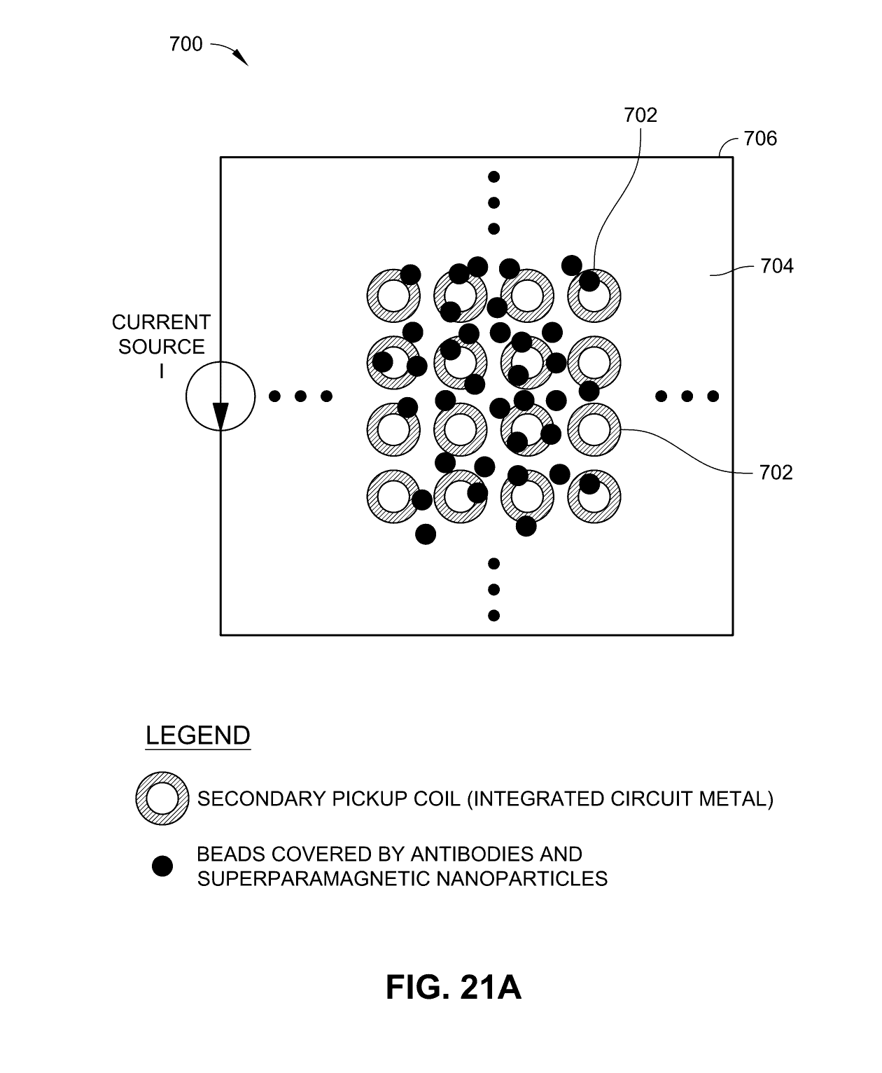

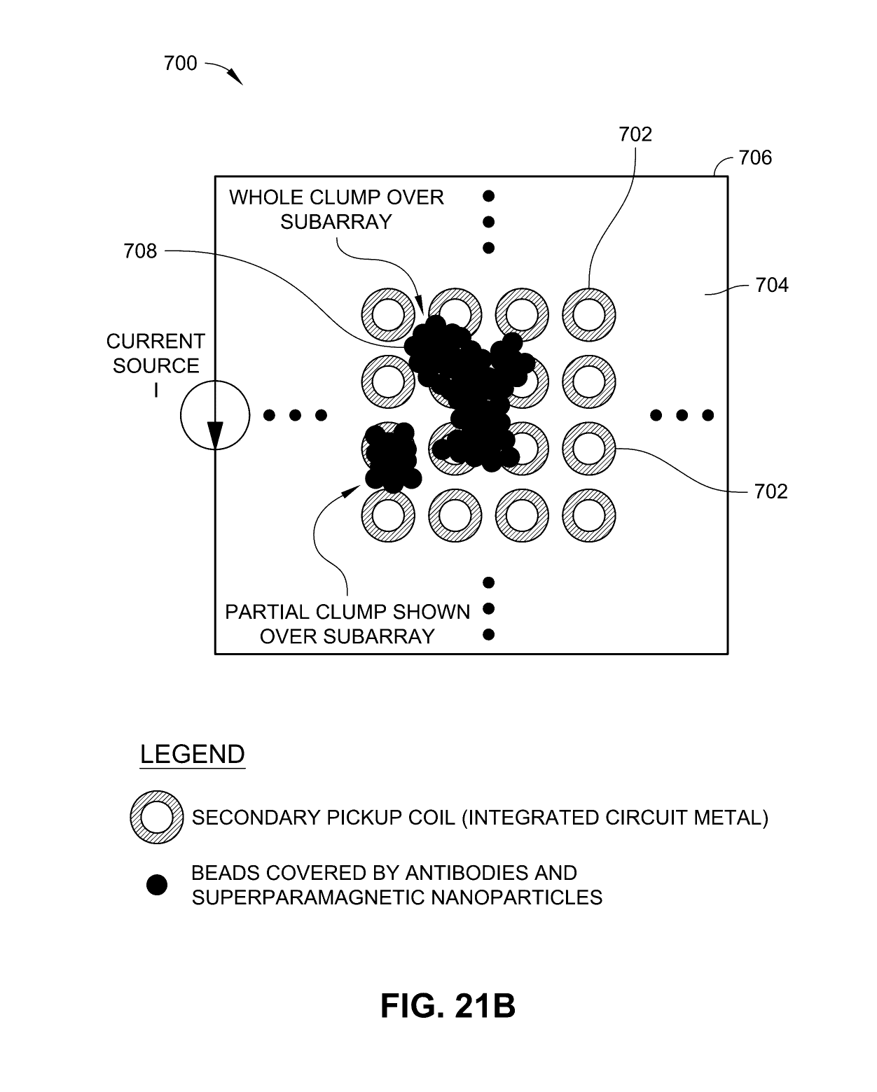

Referring to FIGS. 21A and 21B, in an agglutination assay, beads that are covered with superparamagnetic nanoparticles functionalized with agents that have an affinity for the target entity are mixed into the sample. In embodiments, the magnetic-field imager 700 can be configured to perform agglutination or agglomeration assays including, but are not limited to, immunoassays, kinetic agglutination assays, agglomeration-of-beads assays, kinetic agglomeration-of-beads assays, coagulation assays, kinetic coagulation assays, surface antigen assays, receptor assays from biopsy procedures, circulating blood cells assays, and/or circulating nucleic acid assays (see, e.g., Michael Fleischhacker et al., Circulating nucleic AIDS (CNAs) and cancer—A survey, Biochimica et Biophysica Acta (February 2007)). If the target entity is present in the sample, then the beads clump together at a rate dependent upon the concentration of the target entity in the sample. As shown in FIG. 21B, clumps 708 of beads may extend over portions of one or more coils 702 (i.e., pixels). In one or more implementations, one or more coils 702 detect a change in the magnetic field as a result of the clumps 708 being directly disposed over the respective coils 702. For example, adjacent coils 702 may detect a change in a magnetic field due to a clump 708 being located directly over the adjacent coils indicating the presence and the density of superparamagnetic nanoparticles. For example, the magnetic-field imager 700 may determine a presence and density of superparamagnetic nanoparticles based upon the number of adjacent coils 702 detecting a change in magnetic field due to the location of the clumps 708 with respect to the adjacent coils 702.

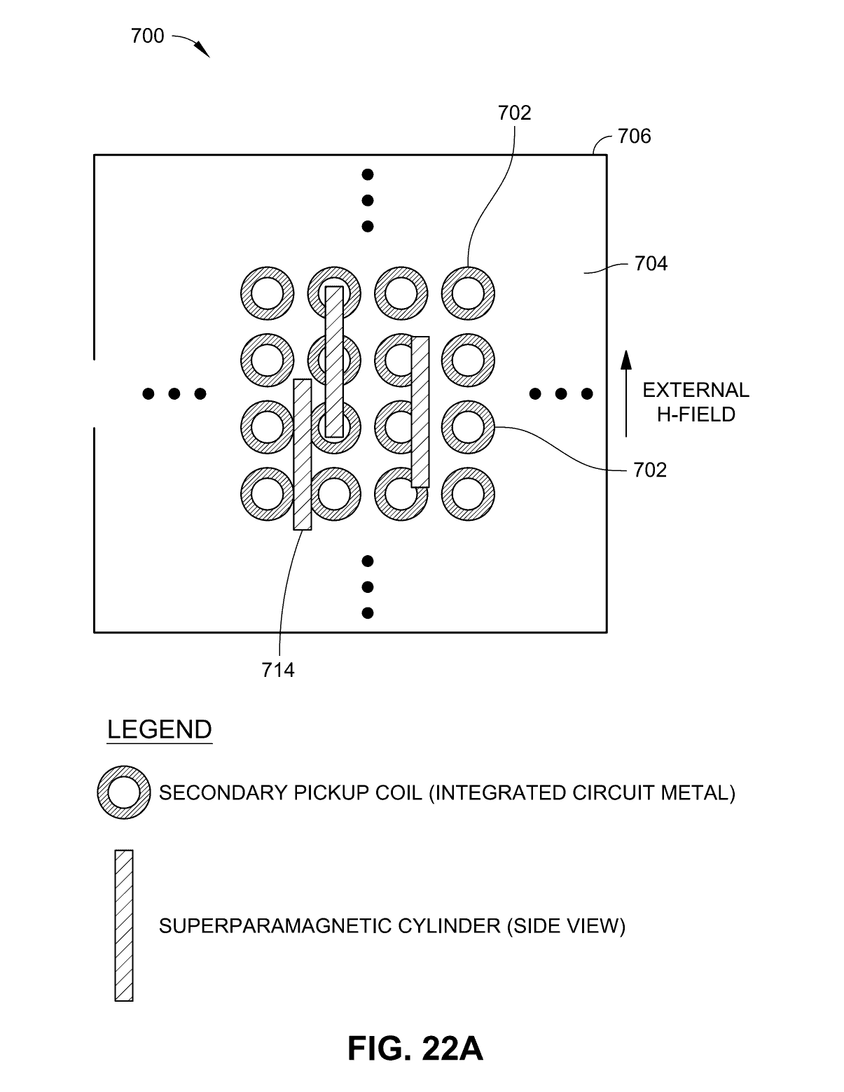

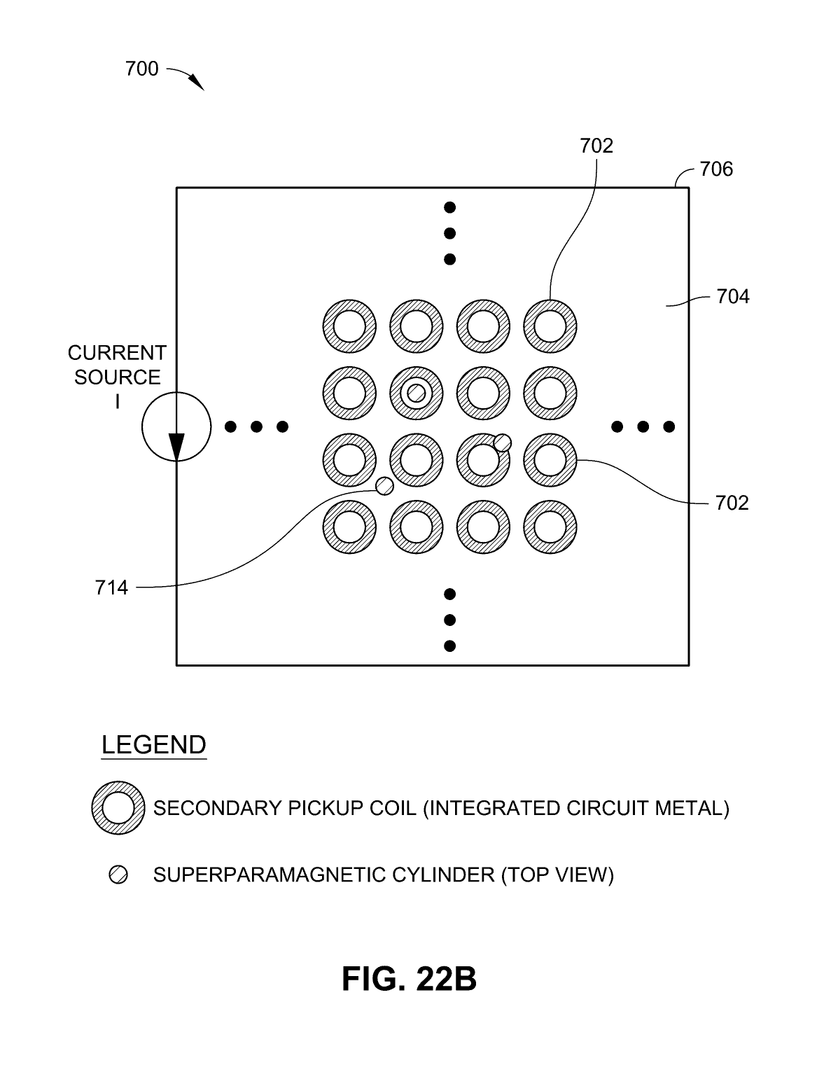

FIGS. 22A and 22B show an implementation of the magnetic-field imager 700 configured to perform a coagulation assay, wherein a biological sample, such as a blood sample, may be disposed over the panel 704 of the magnetic-field imager 700. In such an implementation, superparamagnetic cylinders 714 can be added to the biological sample. An external magnetic field that is parallel to a plane defined by the panel 704 can be generated that causes the superparamagnetic cylinders 714 to align parallel with respect to the surface of the panel 704. In one or more implementations, one or more attributes of the biological sample can be determined. For example, a coagulation measurement of the biological can be determined by terminating the external magnetic field and causing current to flow through the primary excitation coil 706, which causes generation of a magnetic field that is perpendicular to the surface of the panel 704. The magnetic field perpendicular to the surface of the panel 704 causes the superparamagnetic cylinders 714 to transition from at least substantially parallel with respect to the surface of the panel 704 to at least substantially perpendicular with respect to the surface of the panel 704. One or more coils 702 detect the changes in magnetic field as the super paramagnetic cylinder rotates from parallel to perpendicular with respect to the surface of the panel 704. In one or more implementations, a controller of the magnetic-field imager 700 measures a time ranging from the termination of the external magnetic field to the detecting a presence of the superparamagnetic cylinder 714 due to it being at least substantially perpendicular to the surface of the panel 704. Based upon the measured time, the controller can determine a coagulation characteristic of the biological sample.

As previously discussed herein, the magnetic-field imager 700 may include processing logic embodied by a controller or any programmable logic device, e.g., a controller/microcontroller, a single or multiple core processor, an ASIC, an FPGA, or the like. The processing logic may be configured to generate an image based on changes in the magnetic field detected by one or more coils 702. In embodiments, the processing logic can include fast Fourier transform (FFT) and magnetic field detection algorithms. The processing logic can further include one or more computer imaging software modules executable by a processor/controller to identify attributes of cells/particles (e.g., superparamagnetic nanoparticles) in the generated magnetic-field image. For example, the computer imaging modules may cause the processor/controller to perform a comparison between one or more portions of the generated magnetic-field image and a library with stored images or data associated with one or more attributes, such as size, type, morphology, distribution, number of cells, and so forth.

In some embodiments, the magnetic-field imager 700 can be configured to collect multiple magnetic-field images taken at different times (e.g., time lapsed images) to monitor growth or movement of superparamagnetic nanoparticles (or magnetic nanoparticles). For example, time lapsed images from an agglutination assay can be used to monitor movement of dispersed particles (e.g., antibody-coated beads) as they agglutinate in the presence of an antigen.

In various embodiments of the present disclosure, the magnetic-field imager 700 may be at least partially powered by a near-field communications (NFC) device. For example, the mobile electronic device 116 having NFC technology may be positioned proximate to the magnetic-field imager 700 (e.g., where the magnetic-field imager 700 is implemented in the sensor module 104 of the mobile detection or measurement device 100). Due to the proximity to the NFC technology of the mobile electronic device, the magnetic-field imager 700 may be at least partially powered by the NFC technology. The mobile electronic device 116 can also communicate with the magnetic-field imager 700 using NFC or any other short-range wireless communication protocol as discussed herein with regards to various implementations of the mobile sample analysis system 114. In some embodiments, communication and/or power transfer between the magnetic-field imager 700 and a stationary electronic device/computer can also be implemented with NFC or other short-range wireless communication protocols.

Additional Sensor Implementations—Multi-Modal Imager

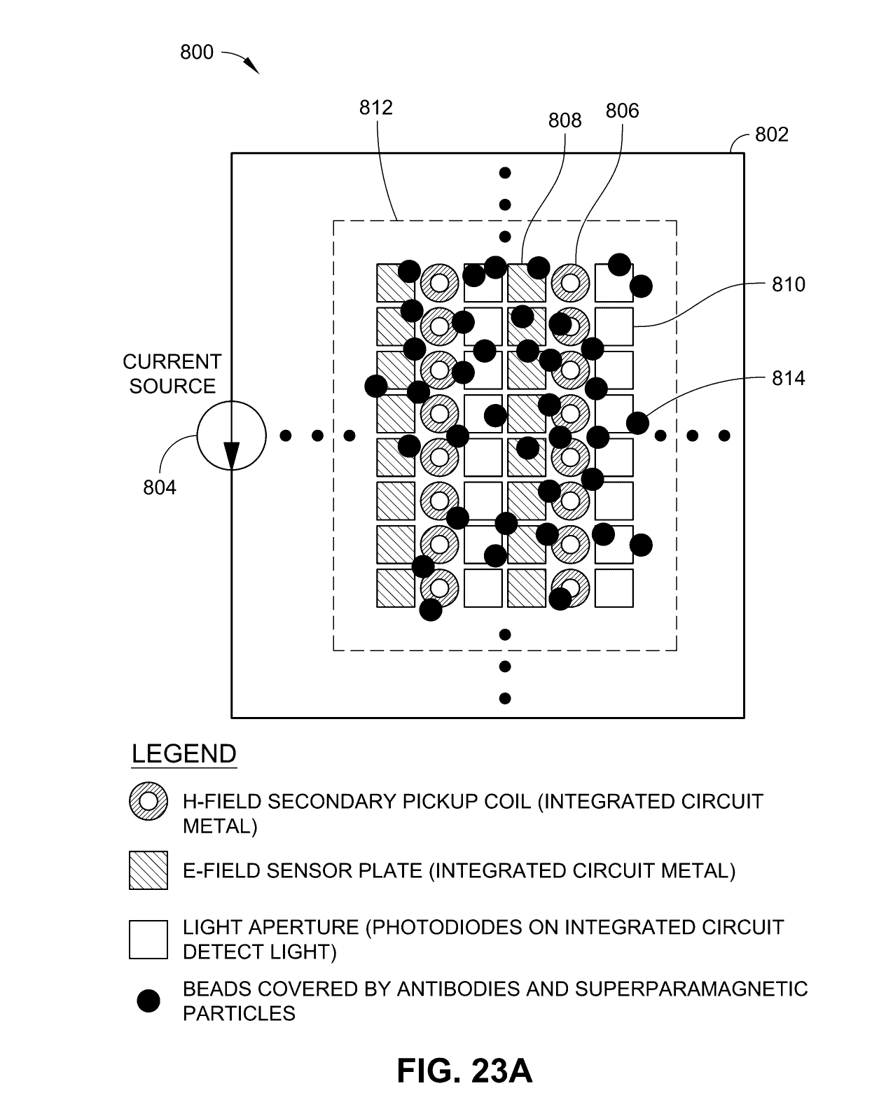

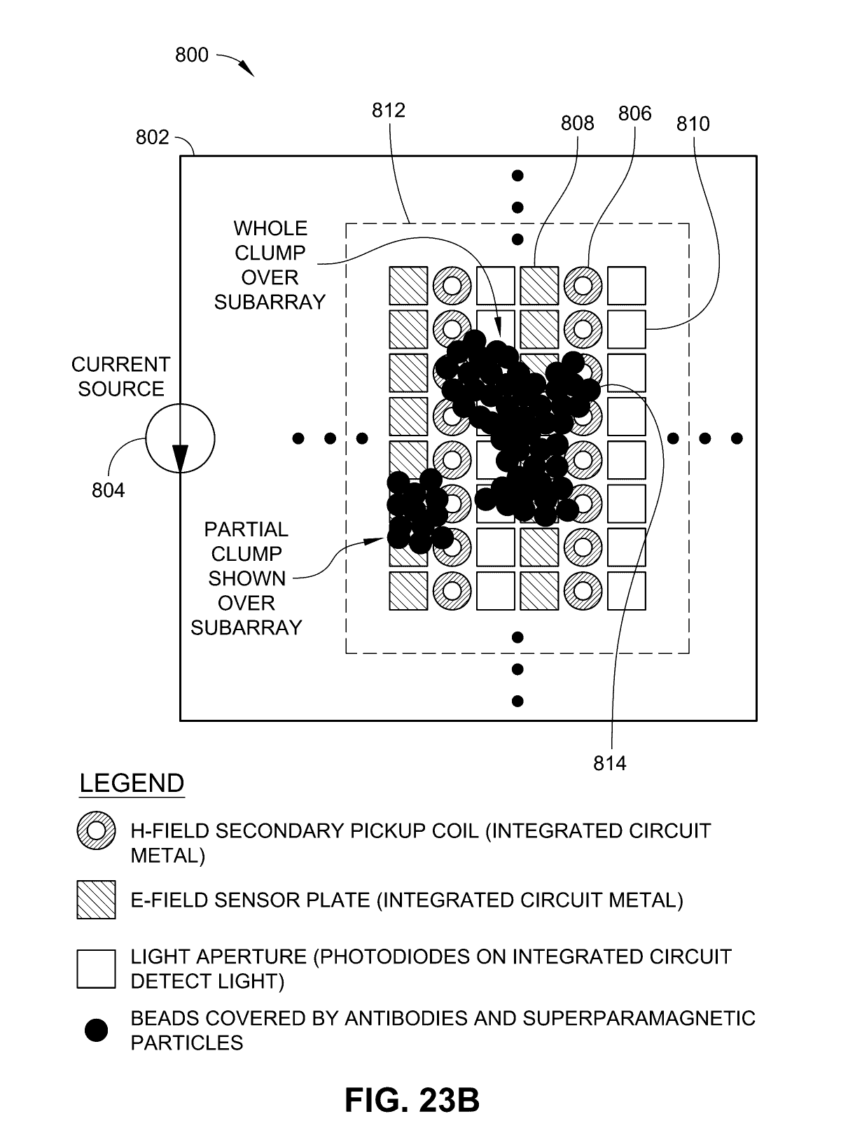

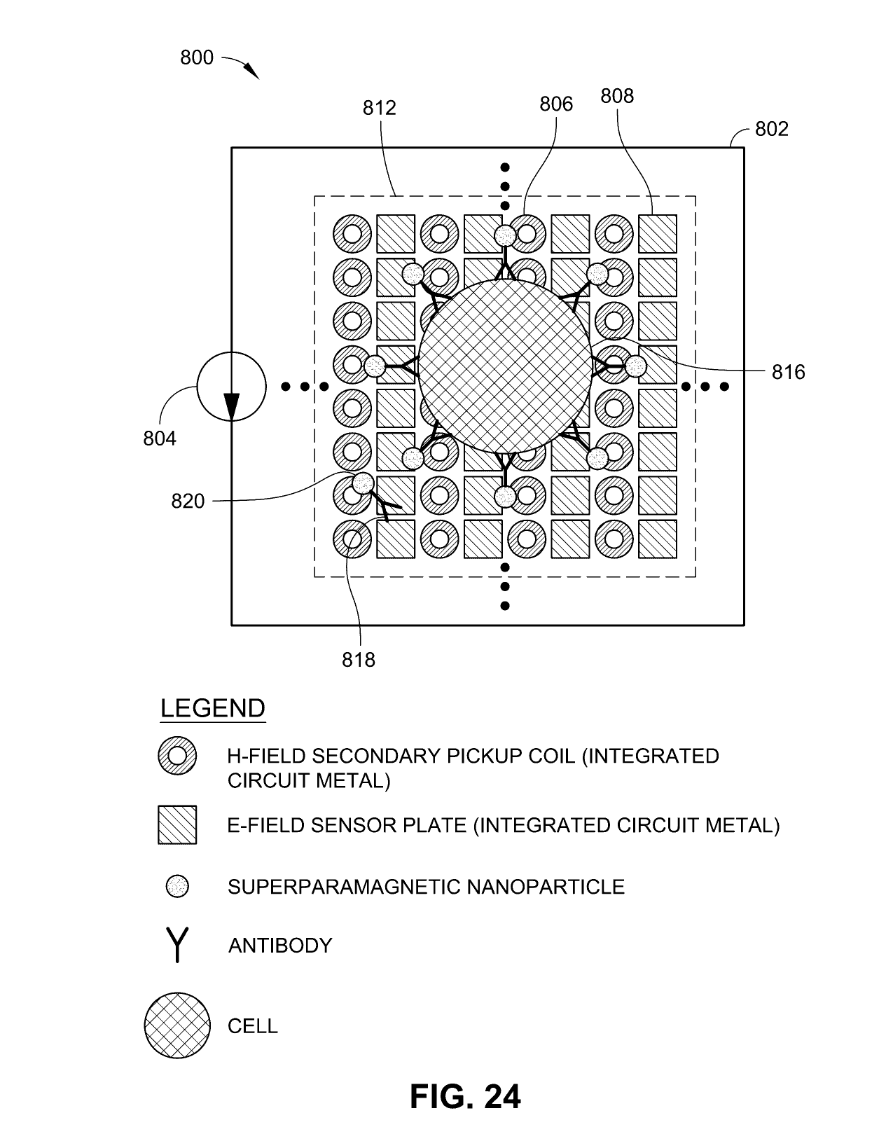

FIGS. 23A through 24 illustrate a multi-modal imager 800 in accordance with various embodiments of this disclosure. In embodiments illustrated in FIGS. 23A and 23B, the multi-modal imager 800 is shown to include sensor elements for three sensing modalities, an electric field sensor, a magnetic field sensor, and an optical sensor. In some embodiments, only two sensing modalities are included in multi-modal imager 800. For example, the multi-modal imager 800 can include an electric field sensor and a magnetic field sensor (e.g., as shown in FIG. 24), or an optical sensor and a magnetic field sensor. In some embodiments, pixels corresponding to each of the sensing modalities are defined by adjacent rows of sensor elements. For example, pixels can be defined by secondary coils 806 making up the active sensor area of the magnetic-field sensor. Pixels can also be defined by conductive metal panels 808 making up the active sensor area of the electric-field sensor. Pixels can also be defined by light sensors 810 (e.g., photodiodes) making up the active sensor area of the optical sensor. Any combination of two or more of these different sensor element types can be implemented to form pixels of the active sensor area of the multi-modal imager 800.

In embodiments including a magnetic-field sensor, the magnetic-field sensor can further include a primary coil 802 driven by a current source 804 to induce a primary magnetic field, where the secondary coils 806 detect changes in a local magnetic field due to proximity of magnetic, paramagnetic, or superparamagnetic nanoparticles in the fluid sample with respect to at least one secondary coil 806 of the plurality of secondary coils 806. For example, the secondary coils 806 can detect changes in a local magnetic field due to proximity of one or more target analytes (e.g., cells or viruses) which have magnetic or superparamagnetic nanoparticles attached to them. In embodiments including an electric-field sensor, the metal panels 808 can detect changes in impedance or charge caused by the target analytes in the fluid sample. In embodiments including an optical sensor, the light sensors 810 can detect light that is transmitted, reflected, scattered, refracted, emitted, or radiated by analytes in the fluid sample.

The active sensor area formed by overlapping sensor areas of different sensor types can be covered by a substrate 812 that seals the various sensor elements and/or other system hardware from the fluid sample, which can be deposited on the substrate 812 for imaging/analysis. In implementations, the substrate 812 comprises any suitable material (e.g., an integrated circuit passivation layer, glass panel, or plastic substrate) that allows the sensor elements to operate as described herein without making physical contact with the fluid sample.

Other types of sensor configurations can be implemented without departing from the scope of this disclosure, so long as the multi-modal imager 800 includes at least two sensing modalities with shared (e.g., overlapping) active sensor areas. For example, various embodiments of electric-field sensors and magnetic-field sensors are described above. Overlapping active sensor areas can be formed by adjacently placed or layered sensor elements of the different sensor types to form a multi-modal sensor grid. The overlapping active sensor areas can also be formed by two distinct sensor areas/surfaces, each corresponding to at least one sensor type, where the two sensor areas are configured to sandwich a sample in between the two surfaces.

In some embodiments, the magnetic-field sensor can include a plurality of coils 806 (e.g., an array of coils deployed through the multi-modal imaging system 800) for detecting changes in magnetic fields. Each coil 806 can define a pixel within the magnetic field image sensor's active sensor area. In this manner, the array of coils 806 defines an active sensor area where the fluid sample, including cells, viruses, and/or other analytes, can be deposited over such that respective coils 806 can detect a change in the magnetic field caused by magnetic nanoparticles, paramagnetic nanoparticles, or superparamagnetic nanoparticles that are used to tag the analytes. In one or more implementations, the pitch between respective coils can vary from 10 nanometers to 100 micrometers.

As shown in FIG. 23A, the multi-modal imager 800 can include a primary excitation coil 802 disposed about the active sensor area. The primary excitation coil 802 causes generation of a magnetic field that is perpendicular to a plane of the active sensor area when current flows through the primary excitation coil 802. If magnetic nanoparticles are in the fluid sample, then they will rotate such that their magnetic moments will be aligned parallel to the magnetic field. If superparamagnetic nanoparticles are in the sample, then the magnetic field generated by the primary excitation coil 802 induces magnetism in the superparamagnetic nanoparticles, which align their resulting magnetic moments parallel to the magnetic field. In addition, the magnetic field interacts with the magnetic moment of the magnetic nanoparticles or the superparamagnetic nanoparticles and pulls them to the plane of the active sensor area.

In some implementations, a magnetic-field sensor can be used to count the number of cells in a fluid sample. For example, the target cells might be infectious bacteria in whole human blood. Super paramagnetic nanoparticles functionalized with antibodies that bind to structures on the target cell can be mixed into the sample. The super paramagnetic nanoparticles attach to the target cells. Once the primary excitation coil 802 is turned on, the super paramagnetic nanoparticles align themselves to the primary magnetic field. The nanoparticles are pulled to the active sensor area, which senses the presence and amount of nanoparticles on a pixel-by-pixel basis. Target cells have a much higher number of nanoparticles attached to it than can be found elsewhere in the sample. Suitable algorithms can interpret the resulting image frame to determine the number of cells for a given sample volume. Sequentially or in parallel, the fluid sample can be imaged by the electric-field sensor and/or optical sensor to visualize the cellular structures at higher resolution, where the magnetic-field sensor's imaging data can be used to assist in identifying cells of interest (e.g., cells labeled with magnetic or superparamagnetic nanoparticles).

Referring to FIG. 24, magnetic-field sensor elements (e.g., coils 806) may sense the magnetic nanoparticles but can lack ability to visualize the cell. Electric-field sensor elements (e.g., metal panels 808) can sense the cell and possibly the magnetic nanoparticles; however, signals coming off the electric field sensor can be quite busy when the fluid sample has multiple cells (e.g., such as in whole human blood). Absolute count accuracy is important when detecting bacterial or viral infection, and as such, the magnetic-field sensor modality may be better suited for counting applications, while the electric-field modality may be better suited for imaging cells and viruses. With both imaging modalities available, a composite image can be created of both the label and the antigen to which the label is attached.

The multi-modal imager 800 can implement modalities for two, three, or more sensor types where imaging data is collected in parallel or sequentially with all three sensors or where one or two of the sensor types are selected based on the needs of a particular application. For example, the magnetic field sensor operates better than an electric field sensor or optical sensor when counting pathogens, whereas the electric field sensor or the optical sensor may show better results for measuring cellular growth, counting cells, or visualizing cells or viruses at high resolution.

To further illustrate advantages of the multi-modal imager 800 described herein, it is noted that the magnetic field sensor can be superior to an electrical sensor or optical sensor if there are magnetic beads in the fluid sample, providing amplification to signal quality of the magnetic field sensor. Similarly, the optical sensor can provide superior results if appropriate fluorescent molecules are available in the fluid sample. If there are dielectric or charged tags, the electric field sensor may provide the best imaging/detection signal quality. Multi-modal imaging can therefore provide advantages, should there be any constraints on resources for helping to identify antigens such as beads or fluorescent molecules. Additionally, in a tag-less mode, where there is potentially low signal strength in any of the three modalities, the combination of more than one sensing modality can assist in reducing false positive and negative results.

Referring to FIGS. 23A and 23B, in an agglutination assay, superparamagnetic nanoparticle beads 814 that are covered with functionalizing agents that have an affinity for the target entity are mixed into the fluid sample. If the target entity is present in the sample, then the beads clump together at a rate dependent upon the concentration of the target entity in the sample. As shown in FIG. 23B, clumps of beads 814 may extend over portions of one or more sensor elements (e.g., pixels). In one or more implementations, one or more coils 806 detect a change in the magnetic field as a result of the clumps being directly disposed over the respective coils 806. For example, adjacent coils 806 may detect a change in a magnetic field due to a clump being located directly over the adjacent coils indicating the presence and the density of superparamagnetic nanoparticles. A presence and density of superparamagnetic nanoparticles can be determined based upon the number of adjacent coils 806 detecting a change in magnetic field due to the location of the clumps of beads 814 with respect to the adjacent coils 806.

The electric-field sensor pitch may be defined by panel length, width, and/or panel-to-panel separation. The system 800 can have sensor pitch (i.e., pixel size and spacing) for the electric field sensor and/or other sensing modalities that is appropriate for imaging viruses, cells and/or various cellular structures (e.g., a cell's nucleus). To properly image individual analytes, the sensor pitch may be higher frequency than a Nyquist spatial sampling rate suitable for detecting a smallest member of a group of target analytes (e.g., viruses or cells of interest). In some implementations, detection of cellular structures, morphology, or volume can be used to distinguish between different types of biological cells (e.g., white blood cells vs. red blood cells).

The multi-modal imager 800 may further include processing logic embodied by a programmable logic device, a controller/microcontroller, a single or multiple core processor, an ASIC, or the like. The processing logic may be configured to generate an image based on changes in the magnetic field detected by one or more coils 806, impedance, charge, or changes in impedance/charge detected by the electric field sensor elements 808, and/or transmitted, reflected, scattered, refracted, emitted, or radiated light that is detected by the light sensor elements 810. In embodiments, the processing logic can include fast Fourier transform (FFT), object sense algorithms, magnetic field sense algorithms, and impedance sense algorithms. The processing logic can further include one or more computer imaging software modules executable by a processor/controller to identify attributes of one or more analytes in the generated electric-field image. For example, the computer imaging modules may cause the processor/controller to perform a comparison between one or more portions of the generated electric field, magnetic field, or optical sensor image and a library with stored images or data associated with one or more attributes, such as size, type, morphology, volume, distribution, number of cells, and so forth. In some embodiments, the multi-modal imager 800 can be configured to collect multiple image frames taken at different times (e.g., time lapsed images) to monitor growth or movement of cells. For example, time lapsed images can be used to monitor cells as they multiply or for agglutination assaying to monitor how quickly the dispersed particles (e.g., antibody-coated microbeads 814 shown in FIG. 23A) agglutinate in the presence of an antigen (e.g., as shown in FIG. 23B).

In some embodiments, the multi-modal imager 800 can include multiple-sensor areas or regions with different sensor pitches/dimensions for targeting smaller particles (e.g., viruses) vs. larger particles (e.g., cells). For example, a first area with larger sensor pitch can be used to image cells or larger particles. This can be useful in cases where smaller particles are not of interest and/or cases where speed is more important than resolution. On the other hand, a second area with finer sensor pitch can be used to collect higher resolution images and detect viruses and/or resolve cellular structures. At finer resolutions, both large and small particles may be detected.

In some embodiments, the multi-modal imager 800 can further include a thermal sensor configured to detect a temperature of the fluid sample and/or a conductivity sensor configured to detect a conductivity of the fluid sample or portions thereof. In some implementations, the electric field sensor elements 808 can be configured to detect the overall conductivity of the fluid sample or sample conductivity at different regions of the active sensor area.

In various embodiments of the present disclosure, the multi-modal imager 800 may be at least partially powered by a near-field communications (NFC) device. For example, the mobile electronic device 116 having NFC technology may be positioned proximate to the multi-modal imager 800 (e.g., where the multi-modal imager 800 is implemented in the sensor module 104 of the mobile detection or measurement device 100). Due to the proximity to the NFC technology of the mobile electronic device, the multi-modal imager 800 may be at least partially powered by the NFC technology. The mobile electronic device 116 can also communicate with the multi-modal imager 800 using NFC or any other short-range wireless communication protocol as discussed herein with regards to various implementations of the mobile sample analysis system 114. In some embodiments, communication and/or power transfer between the multi-modal imager 800 and a stationary electronic device/computer can also be implemented with NFC or other short-range wireless communication protocols.

It is recognized that the various functions, operations, blocks, or steps described throughout the present disclosure may be carried out in any order, by any combination of hardware, software, or firmware. For example, various steps or operations may be carried out by one or more of the following: electronic circuitry, logic gates, multiplexers, a programmable logic device, an application-specific integrated circuit (ASIC), a controller/microcontroller, or a computing system. The term “controller” is defined herein to encompass any device having one or more processors that execute instructions from a carrier medium.

Program instructions implementing methods, such as those manifested by embodiments described herein, may be transmitted over or stored on carrier medium. The carrier medium may be a transmission medium, such as, but not limited to, a wire, cable, or wireless transmission link. The carrier medium may also include a non-transitory signal bearing medium or storage medium such as, but not limited to, a read-only memory, a random access memory, a magnetic or optical disk, a solid-state or flash memory device, or a magnetic tape.

It is further contemplated that any embodiment of the disclosure, manifested above as a system or method, may include at least a portion of any other embodiment described herein. Those having skill in the art will appreciate that there are various embodiments by which systems and methods described herein can be implemented, and that the implementation will vary with the context in which an embodiment of the disclosure is deployed.

Furthermore, it is to be understood that the invention is defined by the appended claims. Although embodiments of this invention have been illustrated and described herein, it is apparent that various modifications may be made by those skilled in the art without departing from the scope and spirit of the disclosure.

What is claimed is:

1. A system comprising:
a mobile detection or measurement device including a sensor configured to receive at least a portion of a fluid sample and a wireless transmitter or transceiver configured to transmit information associated with electrical signals received from the sensor, the electrical signals being at least partially attributable to one or more analytes in the fluid sample; and
a mobile electronic device in communication with the mobile detection or measurement device, the mobile electronic device including a short-range wireless transceiver configured to receive the information from the mobile detection or measurement device, the mobile electronic device configured to provide one or more detection or measurement results based upon the information from the mobile detection or measurement device.

2. The system as recited in claim 1, wherein the mobile electronic device is configured to at least partially or entirely power the mobile detection or measurement device when the mobile detection or measurement device is positioned proximate to the mobile electronic device.

3. The system as recited in claim 1, wherein the mobile electronic device is communicatively connected to a cloud computing network.

4. The system as recited in claim 3, wherein the cloud computing network includes one or more processors configured to determine one or more detection or measurement results based upon the information from the mobile detection or measurement device.

5. The system as recited in claim 3, wherein the cloud computing network is configured to supply one or more software modules executable by the mobile electronic device to determine one or more detection or measurement results based upon the information from the mobile detection or measurement device.

6. The system as recited in claim 3, wherein a client device associated with medical personnel is communicatively coupled to the cloud computing network, the client device configured to retrieve detection or measurement results from the cloud computing network.

7. The system as recited in claim 3, wherein a patient medical record management entity is communicatively coupled to the cloud computing network, the patient medical record management entity configured to retrieve detection or measurement results from the cloud computing network.

8. The system as recited in claim 3, wherein the cloud computing network comprises a multi-user, multi-device, collaborative patient medical record management platform accessible by a patient and two or more care providers practicing at different care providing organizations.

9. The system as recited in claim 8, wherein the multi-user, multi-device, collaborative patient medical record management platform selectively provides access to patient history, test results, treatments, diagnostics, demographics and patient identity information stored by the cloud computing network.

10. The system as recited in claim 9, wherein the multi-user, multi-device, collaborative patient medical record management platform is further configured to selectively provide access to one or more of the test results, treatments, diagnostics, and demographics stored by the cloud computing network, dissociated from the patient identity information.

11. The system as recited in claim 9, wherein the multi-user, multi-device, collaborative patient medical record management platform is further configured to selectively provide access to analysis or trends based upon one or more of the test results, treatments, diagnostics, and demographics stored by the cloud computing network, dissociated from the patient identity information.

12. The system as recited in claim 3, wherein the cloud computing network is configured to store contextual information regarding the mobile measurement or detection device, the contextual information comprising at least one of a time, a date, or a location.

13. The system as recited in claim 3, wherein the cloud computing network is configured to track an inventory of mobile measurement or detection devices, where an inventory count is reduced when the mobile measurement or detection device is used.

14. The system as recited in claim 3, wherein the cloud computing network is configured to provide an alert, an option to order, or communicate an automated order when the inventory count is reduced below a threshold inventory of mobile measurement or detection devices.

15. The system as recited in claim 1, wherein the mobile detection or measurement device comprises a single-substrate integrated laboratory, wherein the sensor and the wireless transmitter or transceiver are mounted on or within the single-substrate integrated laboratory.

16. The system as recited in claim 15, wherein the mobile detection or measurement device further includes a controller coupled to the sensor and configured to receive the electrical signals from the sensor, the controller being mounted on or within the single-substrate integrated laboratory, wherein the controller is configured to transmit the information associated with the electrical signals received from the sensor to the mobile electronic device, via the wireless transmitter or transceiver.

17. The system as recited in claim 1, wherein the sensor comprises a plurality of sensors, including at least a first sensor tuned to detect analyte concentrations in a first analyte concentration range and a second sensor tuned to detect analyte concentrations in a second analyte concentration range different from the first analyte concentration range.

18. The system as recited in claim 1, wherein the mobile electronic device is configured to reject a sensor measurement associated with the fluid sample when the fluid sample is associated with a negative environmental or sample condition detected by a secondary sensor.

19. The system as recited in claim 1, wherein the mobile electronic device is configured to receive at least one sensor measurement associated with a first analyte and at least one sensor measurement associated with a second analyte different from the first analyte, and wherein the mobile electronic device is further configured to adjust the at least one sensor measurement associated with the first analyte based on the at least one sensor measurement associated with the second analyte.

20. A mobile detection or measurement device, comprising:
a single-substrate integrated laboratory;
a sensor configured to receive at least a portion of a fluid sample, the sensor being mounted on or within the single-substrate integrated laboratory;
a controller coupled to the sensor and configured to receive electrical signals from the sensor, the electrical signals being at least partially attributable to one or more analytes in the fluid sample, the controller being mounted on or within the single-substrate integrated laboratory; and
a wireless transmitter or transceiver configured to transmit data associated with the electrical signals received from the sensor to a mobile electronic device, the wireless transmitter or transceiver being mounted on or within the single-substrate integrated laboratory.
